(19) United States
(12) Patent Application Publication
(10) Pub. No.: US 2009/0052743 A1
(43) Pub. Date: Feb. 26, 2009

(54) MOTION ESTIMATION IN A PLURALITY OF TEMPORALLY SUCCESSIVE DIGITAL IMAGES

(76) Inventor: Axel Techmer, Munich (DE)

Correspondence Address: DICKSTEIN SHAPIRO LLP, 1177 AVENUE OF THE AMERICAS 6TH AVENUE, NEW YORK, NY, 10036-2714, US

(21) Appl. No.: 11/577,131

(22) PCT Filed: Oct. 12, 2005
(86) PCT No.: PCT/DE05/01815

§ 371 Date: Apr. 12, 2007

(30) Foreign Application Priority Data
Oct. 12, 2004 (DE) 10 2004 049 676.5

(51) Int. Cl. G06K 9/00; G06K 9/62

(52) U.S. Cl. 382/107; 382/209

(57) ABSTRACT

Method for computer-aided motion estimation in a plurality of temporally successive digital images. The method includes first partial motion estimating in a second digital image relative to a first digital image temporally preceding the second digital image; constructing a reference image structure from the first digital image and the second digital image based on the first partial motion estimation, the reference image structure containing at least features from the first digital image and/or the second digital image; second partial motion estimating in a third digital image, which temporally succeeds the second digital image, relative to the second digital image; third partial motion estimating with a comparison of features of the third digital image and of the features contained in the reference image structure; and determining motion in the third digital image relative to the first digital image based on the third partial motion estimation, the second partial motion estimation and the first partial motion estimation.

### CROSS-REFERENCE TO RELATED APPLICATION

This application is a continuation of International Patent Application Serial No. PCT/DE2005/001815, filed Oct. 12, 2005, which published in German on Apr. 20, 2006 as WO 2006/039906, and is incorporated herein by reference in its entirety.

### FIELD OF THE INVENTION

The invention relates to a method for computer-aided motion estimation in a multiplicity of temporally successive digital images, an arrangement for computer-aided motion estimation, a computer program element and a computer-readable storage medium.

### BACKGROUND OF THE INVENTION

Development in the field of mobile radio telephones and digital cameras, together with the widespread use of mobile radio telephones and the high popularity of digital cameras, has led to modern mobile radio telephones often having built-in digital cameras.

In addition, services such as, for example, the multimedia message service (MMS) are provided which enable digital image communications to be transmitted and received using mobile radio telephones suitable for this.

Typically, the components of mobile radio telephones which enable digital images to be recorded do not afford high performance compared with commercially available digital cameras.

The reasons for this are for example that mobile radio telephones are intended to be cost-effective and small in size.

In particular, the resolution of digital images that can be recorded by means of mobile radio telephones with a built-in digital camera is too low for some purposes.

By way of example, it is possible, in principle, to use a mobile radio telephone with a built-in digital camera to photograph printed text and to send it to another mobile radio telephone user in the form of an image communication by means of a suitable service, for example the multimedia message service (MMS), but the resolution of the built-in digital camera is insufficient for this in the case of a present-day commercially available device in a medium price bracket.

However, it is possible to generate, from a suitable sequence of digital images which in each case represent a scene from a respective recording position, a digital image of the scene which has a higher resolution than that of the digital images of the sequence of digital images.

This possibility exists for example when the positions from which digital images of a sequence of digital images of the scene have been recorded differ in a suitable manner.

The recording positions, that is to say the positions from which the digital images of the sequence of digital images of the scene have been recorded, may differ in a suitable manner for example when the plurality of digital images has been generated by recording a plurality of digital images by means of a digital camera held manually over a printed text.

In this case, the differences in the recording positions that are generated as a result of the slight movement of the digital camera that arises as a result of shaking of the hand typically suffice to enable the generation of a digital image of the scene with high resolution.

However, this necessitates calculation of the differences in the recording positions.

If a first digital image is recorded from a first recording position and a second digital image is recorded from a second recording position, an image content constituent, for example an object of the scene, is represented in the first digital image at a first image position and in a first form, which is taken to mean the geometrical form hereinafter, and is represented in the second digital image at a second image position and in a second form.

The change in the recording position from the first recording position to the second recording position is reflected in the change in the first image position to the second image position and the first form to the second form.

Therefore, a calculation of a recording position change which is necessary for generating a digital image having a higher resolution than that of the digital images of the sequence of digital images can be effected by calculating the change in the image position at which image content constituents are represented and the form in which image content constituents are represented.

If an image content constituent is represented in a first image at a first (image) position and in a first form and is represented in a second image at a second position and in a second form, then a motion of the image content constituent or an image motion from the first image to the second image or from the second image relative to the first image will be how this is referred to hereinafter.

Not only is it possible for the position of the representation of an image content constituent to vary in successive images, but the representation may also be distorted or its size may change.

Moreover, the representation of an image content constituent may change from one digital image of the sequence of digital images to another digital image of the sequence of digital images, for example the brightness of the representation may change.

Only the temporal change in the image data can be utilized for determining the image motion. However, this temporal change is caused not just by the motion of objects in the vicinity observed and by the observer's own motion, but also by the possible deformation of objects and by changing illumination conditions in natural scenes.

In addition, disturbances have to be taken into account, e.g. vibration of the camera or noise in the processing hardware.

Therefore, the pure image motion can only be obtained with knowledge of the additional influences or be estimated from assumptions about the latter.

For the generation of a digital image having a higher resolution than that of the digital images of the sequence of digital images, it is very advantageous for the calculation of the motion of the image contents from one digital image of the sequence of digital images to another digital image of the sequence of digital images to be effected with subpixel accuracy.

Subpixel accuracy is to be understood to mean that the motion is accurately calculated over a length shorter than the distance between two locally adjacent pixels of the digital images of the sequence of digital images.

In addition to the above-described “super-resolution”, that is to say the generation of high resolution images from a sequence of low resolution images, methods for motion estimation and methods for motion estimation with subpixel accuracy may furthermore be used
for structure-from-motion methods that serve to infer the 3D geometry of the vicinity from a sequence of images recorded by a moving camera;
for methods for generating mosaic images in which a large high resolution image is assembled from individual smaller images; and
for video compression methods in which an improved compression rate can be achieved by means of a motion estimation.

For certain applications, for example for generating mosaic images, besides the determination of motion in two temporally successive digital images, that is to say the determination of the image motion in a second digital image relative to a first digital image temporally preceding the second digital image, the first digital image and the second digital image having an overlap region, that is to say image content constituents existing which are displayed in the first digital image and in the second digital image, it is furthermore necessary to determine an accurate assignment of images that are not temporally successive to an overall image. This is explained in more detail with reference to FIG. 1.

FIG. 1 shows a document 101 to be scanned and a scanned document 102.

In this case, the document 101 to be scanned forms a scene from which a digital overall image, that is to say the scanned document 102, is to be created. In this example, this is effected by the generation of a mosaic image, for example since the digital camera used for generating the digital overall image is not suitable for generating the document 101 to be scanned all at once, that is to say by a single recording of a digital image.

Therefore, the digital camera is clearly moved along a camera path 103 over the document 101 to be scanned and a multiplicity of digital images are recorded by means of the digital camera.

By way of example, an excerpt 104 of the document 101 to be scanned is recorded and a corresponding first overall image part 105 is generated. A second overall image part 106 and a third overall image part 107 representing corresponding excerpts of the document 101 to be scanned are generated in the further procedure.

In order to assemble the overall image parts 105, 106, 107 so as to give rise to a digital overall image of the document 101 to be scanned, it is necessary to determine the camera path 103, that is to say clearly to determine the assignment of the overall image parts 105, 106, 107 to the document 101 to be scanned, that is to say to determine which excerpt of the document to be scanned is in each case represented by the overall image parts 105, 106, 107.

By way of example, it is necessary to ascertain, in the course of generating the overall image, that is to say the document 102 to be scanned, that the first overall image part 105 and the second overall image part 107 have an overlap region 108 and that both accordingly represent an excerpt of the document 101 to be scanned. If this were not ascertained, said excerpt would be represented twice in the overall image finally generated.

Clearly, the position of the digital camera pans back to the starting position, with the result that two digital images that are not directly successive temporally, in this example the first overall image part 105 and the second overall image part 107, have an overlap region 108.

It is necessary, therefore, to determine an assignment of the overall image parts to the document 101 to be scanned, that is to say to determine which excerpt of the document 101 to be scanned, or generally of a scene to be represented, is represented by the overall image parts. This procedure is referred to as image registration. This should also be understood to mean that the way in which a respective excerpt is represented by an overall image part, for example rotated or distorted, is determined.

This assignment could be determined in such a way that, for in each case two successive digital images, the relative image motion between the images is estimated and the entire camera path 103 is determined in this way. This has the disadvantage, however, that the error made during each motion estimation between two successive digital images accumulates in the course of determining the camera path 103. This is greatly disadvantageous in particular when two images that are not directly successive temporally have an overlap region 108, as is the case for the first overall image part 105 and the third overall image part 107 in the above example.

In this case, the mosaic image generated, the scanned document 102 in the above example, may have an offset since the first overall image part 105 and the third overall image part 107 are clearly shifted incorrectly relative to one another, for example.

Known methods for motion estimation of temporally successive images are not suitable for the assignment of two digital images that are not directly successive temporally to an overall image. The reason for this is, in particular, that the digital images possibly have no overlap region and it is accordingly not possible to determine any motion between the images. Furthermore, methods for motion estimation are typically based on the assumption that only small changes in the image data are present. In the case of digital images whose recording instants are separated by comparatively long time, the change in the image data between the digital images may be considerable, however.

H. S. Sawhney, St. Hsu, R. Kumar, Robust Video Mosaicing through Topology Inference and Local to Global Alignment, ECCV'98, pp. 103-118, 1998, discloses an iterative method for image registration. In the context of the method disclosed, a coarse motion estimation for pairs of temporally successive images of a video sequence, that is to say a motion estimation having relatively low accuracy, is carried out. The coarse motion estimation is used for determining a topology of the neighborhood relationships of the images of the video sequence; by way of example, it is determined that the first overall image part 105 in FIG. 1 and the third overall image part 107 are topological neighbors, that is to say (spatial) neighbors having an overlap region 108 in the scanned document 102. As explained, such topological neighbors, such as the first overall image part 105 and the second overall image part 107, arise for example upon panning back a digital camera used to record the images of the video sequence. A further step of the method involves carrying out a motion estimation between topological neighbors, with the result that the image motion estimated for the digital images of the video sequence, that is to say the assignment of the digital images of the video sequence to an overall image representing the recorded scene, is consistent. Since, in this method, firstly the topology of the neighborhood relationships of the digital images is determined, and can only take place if a sufficient number of digital images is present, for example have been recorded by means of a digital camera, and only afterward is the image registration with high accuracy carried out, the image registration can only be created offline, that is to say only when all (or sufficiently many) digital images of the video sequence are already present. In particular, the image registration cannot be carried out during the recording of the video sequence. Furthermore, on account of the coarse motion estimation carried out first, there is a problem in that a high number of degrees of freedom have to be taken into account in the final image registration carried out with high accuracy (after the determination of the topological neighbors). The method in accordance with H. S. Sawhney et al. uses parametric motion models which are determined iteratively. Translation parameters are determined first, then parameters that specify an affine transformation, and finally parameters that specify a projective transformation. What is chosen as a measure of the quality of the assignment of the digital images to an overall image is the absolute difference in the image values, for example the gray-scale values, which, in accordance with the assignment, represent the same point of the recorded scene, that is to say correspond to the same point of the overall image. Consistency is established in the context of the method disclosed by means of global verification of the assignment between topological neighbors. This step is carried out iteratively.

D. Capel, Image Mosaicing and Super-resolution, Springer Verlag, 2003 discloses a method for image registration in which a feature-based approach is used. Significant pixels in the digital images of a video sequence are used as features. The spatial assignment of the digital images of the video sequence to an overall image is determined by means of a statistical method, wherein it is not necessary for the images to temporally succeed one another. A projective transformation is used as a model for the assignment of the images of the video sequence to an overall image. The assignment is carried out in a feature-based manner in order to be able to process images that are not temporally successive and in order thus to make the assignment robust with respect to differences in illumination in the images. In order to determine the assignment of features, clearly the similarity of features, intensity patterns of the local vicinity of the features are used. However, said local vicinity is dependent on the transformation sought, which corresponds to the spatial assignment sought, and differences in illumination between the digital images.

Neither of the methods disclosed in H. S. Sawhney et al. and D. Capel can be used online, that is to say in real-time applications, that is to say that the image registration cannot be effected during the recording of a sequence of digital images by means of a digital camera, but rather only when the digital images (or sufficiently many of the digital images) have already been recorded.

Dae-Woong Kim, Ki-Sang Hong: “Fast global registration for image mosaicing”; Image Processing, 2003. Proceedings. 2003 International Conference on; 14-17 Sep. 2003 (IEEE), discloses a method for image registration in which motion estimations between pairs of temporally successive images are carried out. An accumulation of errors is avoided by carrying out a correction on the basis of a mosaic image onto which the images are mapped.

### BRIEF DESCRIPTION OF THE DRAWINGS

Exemplary embodiments of the invention are illustrated in the figures and are explained in more detail below.

FIG. 1 shows a document to be scanned and a scanned document.

FIG. 2 shows an arrangement in accordance with one exemplary embodiment of the invention.

FIG. 3 shows a printed original in accordance with one exemplary embodiment of the invention.

FIG. 4 shows an overall image, a first digital image and a second digital image in accordance with one exemplary embodiment of the invention.

FIG. 5 shows a flow diagram in accordance with one exemplary embodiment of the invention.

FIG. 6 illustrates the motion estimation between two temporally successive images.

FIG. 7 shows a flow diagram in accordance with one exemplary embodiment of the invention.

FIG. 8 illustrates the image registration in accordance with one exemplary embodiment of the invention.

FIG. 9 shows a flow diagram of a method in accordance with one exemplary embodiment of the invention.

FIG. 10 shows a flow diagram of a determination of a translation in accordance with one exemplary embodiment of the invention.

FIG. 11 shows a flow diagram of a determination of an affine motion in accordance with one exemplary embodiment of the invention.

FIG. 12 shows a flow diagram of a method in accordance with a further exemplary embodiment of the invention.

FIG. 13 shows a flow diagram of an edge detection in accordance with one exemplary embodiment of the invention.

FIG. 14 shows a flow diagram of an edge detection with subpixel accuracy in accordance with one exemplary embodiment of the invention.

FIG. 15 shows a flow diagram of a method in accordance with a further exemplary embodiment of the invention.

FIG. 16 shows a flow diagram of a determination of a perspective motion in accordance with one exemplary embodiment of the invention.

### DETAILED DESCRIPTION OF THE INVENTION

The invention is based on the problem of providing a simple and efficient method for image registration which can be used online, that is to say in real-time applications.

The problem is solved by means of a method for computer-aided motion estimation in a multiplicity of temporally successive digital images, an arrangement for computer-aided motion estimation, a computer program element and a computer-readable storage medium having the features in accordance with the independent patent claims.

Provision is made of a method for computer-aided motion estimation in a multiplicity of temporally successive digital images, in which a first partial motion estimation is carried out in a second digital image relative to a first digital image temporally preceding the second digital image, in which a reference image structure is constructed from the first digital image and the second digital image on the basis of the first partial motion estimation, said reference image structure containing at least features from the first digital image and/or the second digital image and in which a second partial motion estimation is carried out in a third digital image, which temporally succeeds the second digital image, relative to the second digital image. A third partial motion estimation is carried out with comparison of features of the third digital image and of the features contained in the reference image structure and the motion in the third digital image relative to the first digital image is determined on the basis of the third partial motion estimation, the second partial motion estimation and the first partial motion estimation.

Provision is furthermore made of an arrangement for computer-aided motion estimation, a computer program element and a computer-readable storage medium in accordance with the method described above.

The multiplicity of temporally successive digital images is generated for example by the multiplicity of digital images being recorded by means of a digital camera and the digital camera being moved between the recording instants, such that there is an image motion between two digital images of the multiplicity of digital images.

As mentioned above, reference is made hereinafter to an image motion in a second digital image relative to a first digital image if an (at least one) image content constituent is represented in the first digital image at a first (image) position and/or in a first form and is represented in a second image at a second position and/or in a second form. Clearly, the first digital image and the second digital image in this case thus have a common image content constituent which is represented differently, for example at different positions, in accordance with the image motion.

Furthermore, reference is made hereinafter to an image motion in a second digital image relative to a first digital image if the first digital image represents one part of a scene and the second digital image represents another part of a scene.

The motion estimation in the second digital image relative to the first digital image in this case means the assignment to an overall image of the scene, that is to say the determination of which excerpt of the overall image is represented by the second digital image relative to the first digital image, and thus clearly the way in which, that is to say the motion in accordance with which, the represented excerpt has moved from the first digital image to the second digital image in the overall image.

The method provided clearly involves determining in each case the motion between two temporally successive images which overlap. The image referred to above as the first digital image clearly serves as a reference image, that is to say as the digital image relative to which the motion of the other digital images is determined.

One idea on which the invention is based can clearly be seen in the fact that the motion in a digital image relative to a temporally preceding digital image which overlaps the digital image and for which the motion has already been determined is firstly estimated by a first motion estimation of the motion in the digital image relative to the temporally preceding image and this first motion estimation is subsequently corrected by a second motion estimation, the second motion estimation involving the determination of the motion of the digital image, projected onto an overall image (or a reference image structure) in accordance with the first motion estimation, relative to the overall image. In this case, the overall image contains information of temporally preceding digital images whose motion relative to a reference image has already been determined.

Clearly, the overall image is thus constructed progressively from the digital images and each newly added digital image is adapted to the overall image by means of a corresponding motion estimation in which use is clearly made of topologically adjacent data (data that are not temporally adjacent).

What is achieved in this way is that the error arising during the motion estimation between two temporally successive images does not accumulate.

It is not necessary for the reference image structure to be an overall image. The reference image structure may also only comprise feature points, since the latter are sufficient for a motion estimation.

Features are points of the image which are significant in a certain predeterminably defined sense, for example edge points.

An edge point is a point of the image at which a great local change in brightness occurs; for example, a point whose neighbor on the left is black and whose neighbor on the right is white is an edge point.

Formally, an edge point is determined as a local maximum of the image gradient in the gradient direction or is determined as a zero crossing of the second derivative of the image information.

Further image points which can be used as feature points in the method provided are e.g.:
gray-scale value corners, that is to say pixels which have a local maximum of the image gradient in the x and y direction.
corners in contour profiles, that is to say pixels at which a significant high curvature of a contour occurs.
pixels with a local maximum filter response in the case of filtering with local filter masks (e.g. sobel operator, gabor functions, etc.).
pixels which characterize the boundaries of different image regions. These image regions are generated e.g. by image segmentations such as “region growing” or “watershed segmentation”.
pixels which describe centroids of image regions, as are generated for example by the image segmentations mentioned above.

The fact that the reference image structure contains “at least features” should be understood to mean, in particular, that the reference image structure can also contain other image information and coding information, such as, for example, color information, brightness information or saturation information from the first digital image and/or the second digital image.

By way of example, the reference image structure may also be a mosaic image composed of the first digital image and the second digital image.

The method provided is distinguished by its high achievable accuracy and by its simplicity and low computing power requirements.

On account of the simplicity of the method provided, it is possible to implement the method in a future mobile radio telephone, for example, without the latter having to have a powerful and cost-intensive data processing unit.

Furthermore, the method provided can be used for an online image registration, to put it another way for a calculation in real time, that is to say that the assignment of a sequence of digital images to an overall image can be effected during the recording of the sequence of digital images by a digital camera. As a result, it is possible in particular for the user of the digital camera to be provided online with a feedback indication about the path of the digital camera, that is to say about the motion of the digital camera, with the result that it is possible, for example, to avoid the situation where the user moves the digital camera such that “holes” arise in an overall image of a scene that is to be generated.

Preferred developments of the invention emerge from the dependent claims. The further configurations of the invention which are described in connection with the method for computer-aided motion estimation in a multiplicity of temporally successive digital images also apply analogously to the arrangement for computer-aided motion estimation, the computer program element and the computer-readable storage medium.

It is preferred that after determining the motion in the third digital image relative to the first digital image, the reference image structure is supplemented by at least one feature from the third image.

Clearly, the reference image structure is supplemented in the course of the motion estimation by the features (together with the respective position information) whose positions were determined in the last step, with the result that a “more comprehensive” reference image structure is used in the next step, that is to say in the determination of the motion in the temporally succeeding digital image relative to the first digital image.

It is furthermore preferred that the motion in a fourth image, which temporally succeeds the first digital image, the second digital image and the third digital image, relative to the first digital image is determined
using a further reference image structure containing at least features of at least one image temporally preceding the fourth image; in a procedure in which
a fourth partial motion estimation is determined in the fourth digital image relative to a further digital image which temporally precedes the fourth digital image and in which the motion relative to the first digital image has already been determined;
a fifth partial motion estimation is carried out with comparison of features of the fourth digital image and of the features contained in the reference image structure;
the motion is determined on the basis of the fifth partial motion estimation, the fourth partial motion estimation and the motion of the further digital image.

Preferably, the further reference image structure is the reference image structure extended by features from at least one digital image which temporally succeeds the second digital image and temporally precedes the fourth digital image.

It is furthermore preferred for the partial motion estimations to be carried out in a feature-based manner.

The motion estimation on the basis of features is in particular stable relative to changes in illumination.

It is furthermore preferred for the partial motion estimations to be carried out with subpixel accuracy.

This increases the accuracy of the motion estimation.

Preferably, an affine motion model or a perspective motion model is in each case determined in the context of the partial motion estimations.

By means of such motion models, a high accuracy can be achieved but the required computing power can be kept low.

It is also possible, however, to use any other motion models, in particular those which can be represented by polynomials or rational functions.

It is furthermore preferred that the first partial motion estimation, the second partial motion estimation and the third partial motion estimation are carried out by means of the same method for motion estimation in two temporally successive images.

This increases the simplicity of the method since it is not necessary to use different methods for the partial motion estimations.

It is furthermore preferred that in order to carry out the third partial motion estimation, features are mapped onto the reference image structure on the basis of the first partial motion estimation and the second partial motion estimation and the third partial motion estimation is carried out by estimating the motion of the mapped features relative to the features contained in the reference image structure.

The use of features in the context of the third partial motion estimation has the advantage that features can be mapped onto the reference image structure without a loss of accuracy.

Preferably, the method for motion estimation is carried out in the context of generating a mosaic image, calibrating a camera, a super-resolution method, video compression or a three-dimensional estimation.

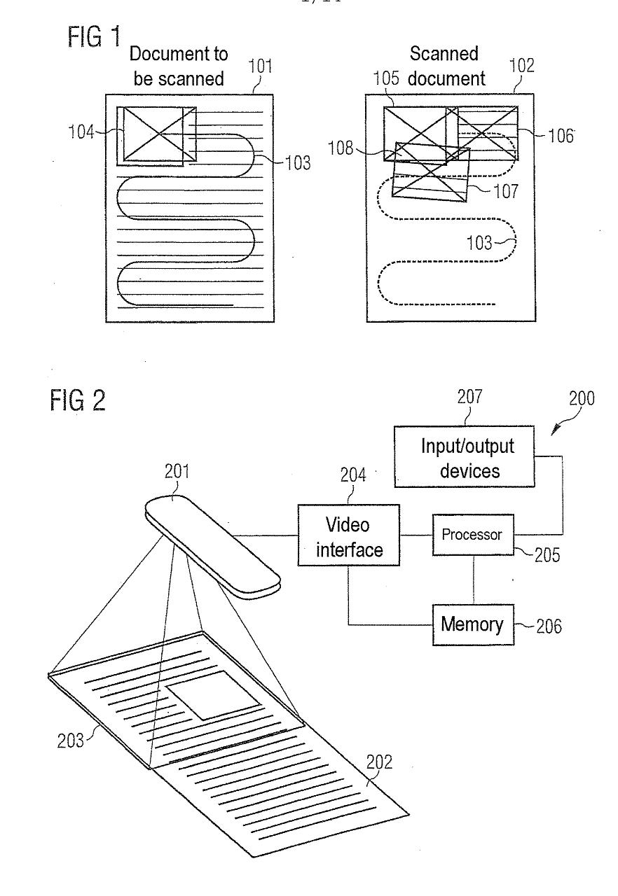

FIG. 2 shows an arrangement 200 in accordance with one exemplary embodiment of the invention.

A digital camera 201, which in this example is contained in a mobile radio subscriber device, is used to record digital images of a scene from which a mosaic image, that is to say an overall image, is to be created. In this example, the digital camera 201 is held by a user over a printed text 202 from which a mosaic image is to be created.

Depending on the holding position of the digital camera 201, an excerpt 203 of the printed text 202, in this example the upper half of the printed text 202, is recorded by means of the digital camera 201. The digital camera 201 is coupled to a processor 205 and a memory 206 by means of a video interface 204.

The digital images which are recorded by means of the digital camera 201 and which in each case represent a part of the printed text 202 can be processed by means of the processor 205 and stored by means of the memory 206. In this example, the processor 205 processes the digital images in such a way that a mosaic image of the printed text 202 is created. The processor 205 is furthermore coupled to input/output devices 207, for example to a screen by means of which the currently recorded digital image or else the finished mosaic image is displayed.

The video interface 204, the processor 205, the memory 206 and the input/output devices 207 are arranged, in one exemplary embodiment, in the mobile radio subscriber device that also contains the digital camera 201.

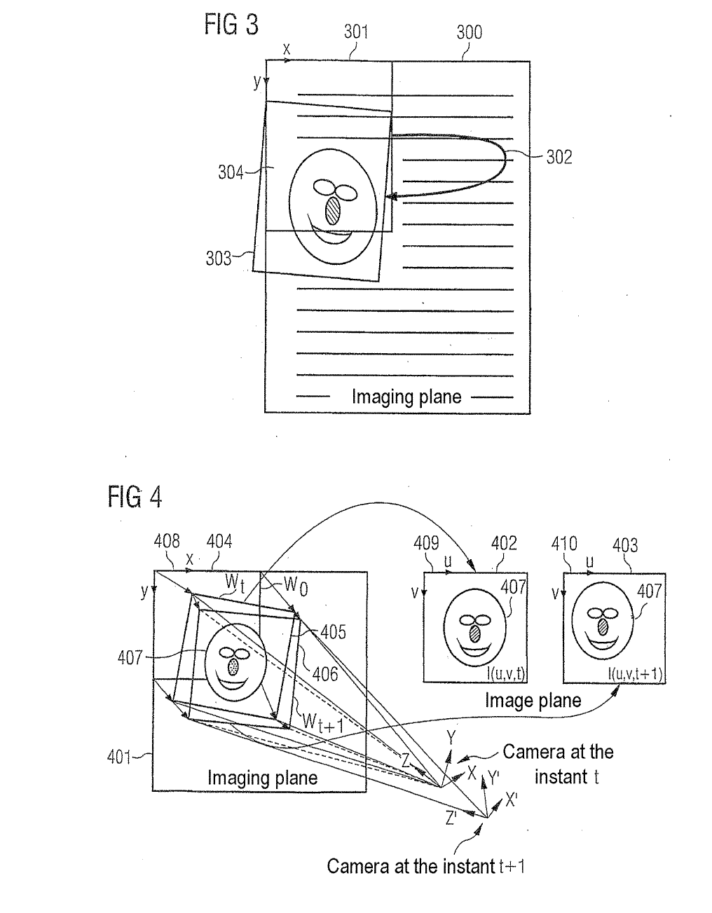

Since the excerpt 203 of the printed text 202 is typically not the entire printed text 202, the digital camera 201 is moved over the printed text 202 by the user in order that an overall image of the printed text 202 can be created. This is explained below with reference to FIG. 3.

FIG. 3 shows a printed original 300 in accordance with one exemplary embodiment of the invention.

The printed original 300 corresponds to the printed text 202. A first digital image is recorded by means of the digital camera 201 at a first instant, said first digital image representing a first excerpt 301 of the printed original 300. In this example, the first excerpt 301 is not approximately half the size of the printed original 300, but rather only approximately a quarter of the size (in contrast to the illustration in FIG. 1).

Afterward, the digital camera 201 is moved along a camera path 302 and a multiplicity of digital images are recorded which represent a corresponding excerpt of the printed original 300 according to the respective position of the digital camera 201. After a time t, a second digital image is recorded by means of the digital camera 201, which has moved along the camera path 302 in the meantime, said second digital image representing a second excerpt 303 of the printed original 300. The first excerpt 301 and the second excerpt 303 overlap in an overlap region 304.

The printed original 300 is situated in the so-called imaging plane. In the case of a three-dimensional scene, the imaging plane is the plane onto which the three-dimensional scene is projected, with the result that the overall image arises which is intended to be generated from a plurality of images or to which a plurality of images are intended to be assigned.

The motion of image excerpts in the imaging plane is explained in more detail below with reference to FIG. 4.

FIG. 4 shows an overall image 401, which, as mentioned, lies in the imaging plane, a first digital image 402 and a second digital image 403 in accordance with one exemplary embodiment of the invention.

A digital mosaic image is to be created from the overall image 401.

Correspondingly, a plurality of digital images of the overall image 401 are recorded by means of the digital camera. A first digital image (not shown) is recorded at a first instant, said first digital image representing a first excerpt 404 of the overall image 401.

The digital camera is subsequently moved and a second digital image 402 is recorded at the instant t, said second digital image representing a second excerpt 405 of the overall image 401.

After a further movement of the digital camera, a third digital image 403 is recorded at the instant t+1, said third digital image representing a third excerpt 406 of the overall image 401.

In this example, the second digital image 402 and the third digital image 403 represent an object 407 (or a constituent) of the scene which is represented by the overall image 401. The representation of the object 407 is shifted and/or rotated and/or scaled in the third digital image 403 relative to the second digital image, however, according to the motion of the digital camera from the instant t to the instant t+1. In this example, the object 407 is represented further to the top left, that is to say shifted toward the top left, in the third digital image 403 relative to the second digital image 402.

In order to generate a mosaic image of the overall image 401, an image registration of the digital images, inter alia of the second digital image 402 and of the third digital image 403, is then carried out, that is to say that the assignment of the digital images to the overall image 401 is determined.

Clearly, the motion of the digital camera at the instant t to the instant t+1 corresponds to a corresponding motion of the second excerpt 405 to the third excerpt 406 in an imaging plane. Correspondingly, reference is made hereinafter to a motion of the excerpt, for example from the second excerpt 405 to the third excerpt 406.

The overall image is provided with a first system 408 of coordinates. Correspondingly, the second digital image 402 is provided with a second (local) system 409 of coordinates and the third digital image 403 is provided with a third (local) system 410 of coordinates.

A method for image registration in accordance with one exemplary embodiment of the invention is explained below, it being assumed in this exemplary embodiment that the motion of the excerpts of the overall image 401 which are represented by the recorded digital images can be approximated by an affine motion model.

It is assumed in the following exemplary embodiment that the digital camera is moved only such that only rotations and/or scalings and/or translations arise in the image plane, that is to say that two excerpts of the overall image 401 which are represented by a respective digital image can differ only by virtue of a rotation and/or a scaling and/or a translation.

A further embodiment of the invention, in which this limitation does not hold true, is explained further below.

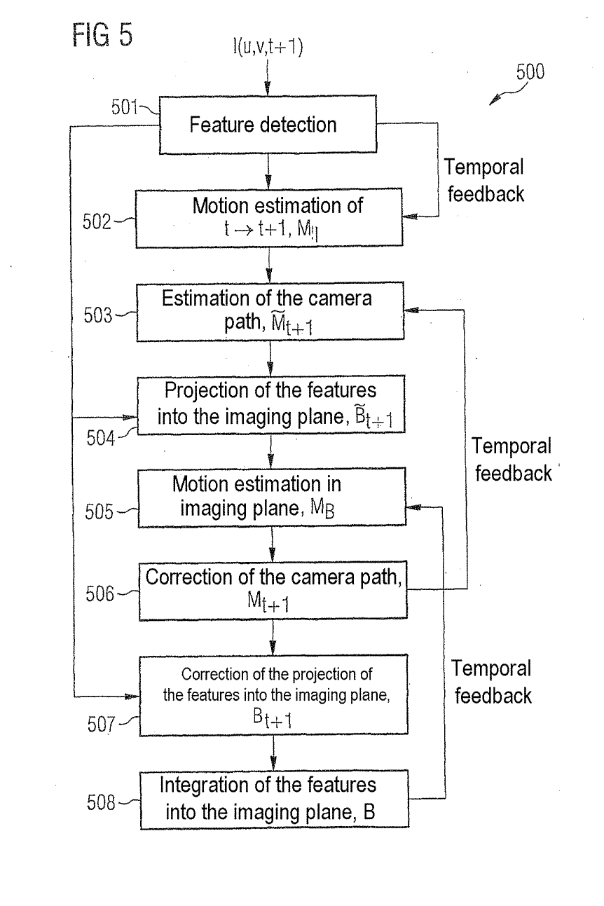

FIG. 5 shows a flow diagram 500 in accordance with one exemplary embodiment of the invention.

The method explained below serves for the image registration of a plurality of digital images. As explained above with reference to FIG. 4, the digital images in each case show an excerpt of an overall image which represents a scene. The overall image is a projection of the scene onto an imaging plane. The overall image, which is to be created for example in the context of generating a mosaic image, is also referred to hereinafter as reference image.

A digital image of the sequence of digital images represents an excerpt of the overall image, as mentioned. The excerpt of the overall image has a specific situation (position, size and orientation) in the overall image which can be specified by specifying the corner points of the excerpt by means of a system of coordinates of the overall image. By way of example, a corner point of the t-th excerpt, that is to say the excerpt represented by the digital image recorded at the instant t, is specified in the following manner:

$${\underline{W}}_{t} = [ \begin{matrix}{x}_{t} \\ {y}_{t} \\ 1\end{matrix} ] \qquad ( 1 )$$

The further corner points of the t-th section are specified analogously.

A corner point of the t+1-th excerpt is specified for example in the following manner:

$${\underline{W}}_{t + 1} = [ \begin{matrix}{x}_{t + 1} \\ {y}_{t + 1} \\ 1\end{matrix} ] \qquad ( 2 )$$

The further corner points of the t+1-th excerpt are specified analogously.

The corner points are specified by means of homogeneous coordinates, that is to say by means of an additional z coordinate, which is always 1, so that an efficient matrix notation is made possible. The respective first coordinate in equation (1) and equation (2) specifies the situation of the respective corner point with respect to a first coordinate axis of the system of coordinates of the overall image (x axis), and the respective second coordinate in equation (1) and equation (2) specifies the situation of the respective corner point with respect to a second coordinate axis of the system of coordinates of the overall image (y axis).

As mentioned, a motion of the digital camera by means of which the sequence of digital images is recorded leads to a corresponding motion of the represented excerpt of the overall image, the represented excerpt at the instant t meaning the excerpt displayed by the digital image recorded at the instant t. In this exemplary embodiment, an affine motion model is used for the motion of the digital camera and for the motion of the represented excerpt of the overall image. By way of example, the following relationship holds true between a first corner point of the t-th excerpt given in accordance with equation (1) and a first corner point of the t+1-th excerpt given by equation (2):

Wₜ₊₁=MWₜ (3)

where

$$\underline{M} = [ \begin{matrix}{m}_{00} & {m}_{01} & {t}_{x} \\ {m}_{10} & {m}_{11} & {t}_{y} \\ 0 & 0 & 1\end{matrix} ] . \qquad ( 4 )$$

The parameters tₓ and t_{y} are translation parameters, that is to say that they specify the translation component of the motion given by M and the parameters m₀₀, . . . , m₁₁ are rotation parameters and scaling parameters, that is to say that they determine the rotation properties and scaling properties of the affine mapping which specifies the affine motion specified by M.

The same correspondingly holds true for the further corner points of the t-th excerpt and of the t+1-th excerpt. It is always tacitly assumed hereinafter that operations which are carried out for one corner point of an excerpt are carried out analogously for the further corner points of the excerpt.

In the case of the sequence illustrated in FIG. 5, it is assumed that the t+1-th excerpt is to be registered, that is to say that the coordinates of the corner points of the t+1-th excerpt are to be determined in the system of coordinates of the overall image. It is assumed that all the preceding excerpts, that is to say the excerpts represented in digital images recorded before the instant t+1, have already been registered. In particular, the coordinates of the corner points of the t-th excerpt are known. Accordingly, a matrix Mt is known which maps the corner points of a 0-th excerpt onto the corner points of the t-th excerpt in accordance with the following equation:

Wₜ=MₜW₀ (5)

The matrix Mₜ specifies the affine motion in accordance with which the represented excerpt has moved from the 0-th excerpt to the t-th excerpt from the instant 0 to the instant t. The 0-th excerpt corresponds for example to the first excerpt 404, the t-th excerpt corresponds for example to the second excerpt 405 and the t+1-th excerpt corresponds for example to the second excerpt 406 in FIG. 4.

As mentioned, it shall be the case, then, that the digital images recorded up to the instant t have already been registered and a digital image recorded at the instant t+1 is to be registered. The coding information of the t+1-th digital image, that is to say of the digital image recorded at the instant t+1, is given by the function I(u,v,t+1), where u and v are the coordinates of a pixel of the t+1-th digital image, that is to say that I(u,v,t+1) specifies the coding information of the point having the coordinates (u,v) (in the system of coordinates of the t+1-th digital image) in the t+1-th digital image.

A feature detection for determining features of the t+1-th digital image is carried out in step 501. Said feature detection is preferably effected with subpixel accuracy.

Step 502 involves carrying out a motion estimation for determining the image motion of the t+1-th digital image relative to the t-th digital image. This is preferably done in a feature-based manner, that is to say using feature points of the t-th digital image and of the t+1-th digital image. The estimated motion shall be given by a matrix M_{I}. That is to say that a point Pₜ having the coordinates (u,v) in the t-th digital image has moved to the point Pₜ₊₁ having the coordinates (uₜ₊₁,vₜ₊₁) in the t+1-th digital image, that is to say that the following equation holds true:

$${\underline{p}}_{t + 1} = [ \begin{matrix}{u}_{t + 1} \\ {v}_{t + 1} \\ 1\end{matrix} ] = {\underline{M}}_{I} [ \begin{matrix}{u}_{t} \\ {v}_{t} \\ 1\end{matrix} ] = {\underline{M}}_{I} {\underline{p}}_{t} \qquad ( 6 )$$

Consequently, M_{I} clearly specifies the motion from the t-th digital image to the t+1-th digital image. From M_{I} and Mₜ, Mₜ₊₁ is then determined, which clearly specifies the camera path at the instant t+1, that is to say the situation of the represented excerpt at the instant t+1. The following formula correspondingly holds true for a corner point of the t+1-th excerpt:

Wₜ+1=Mₜ₊₁W₀ (7)

If W₀ is identical to the origin of the system of coordinates in the overall image, then equation (7) describes a coordinate transformation between the system of coordinates of the t+1-th digital image and the system of coordinates of the overall image. Clearly, the coordinate transformation transfers points from the image plane, that is to say in this case from the t+1-th digital image, into the imaging plane. The same analogously holds true for Mₜ and, consequently, the following holds true:

B=MₜPₜ (8)

where B contains the coordinates in the system of coordinates of the overall image of the point whose coordinates in the system of coordinates of the t-th digital image are given by the vector Pₜ. The following correspondingly holds true:

Pₜ=Mₜ⁻¹B. (9)

The following analogously holds true for points of the t+1-th digital image

B=Mₜ₊₁Pₜ₊₁ (10)

and

Pₜ₊₁=Mₜ₊₁⁻¹B (11)

Combination of equation (6) and equation (9) yields

Pₜ₊₁=M_{I}Pₜ=M_{I}Mₜ⁻¹B. (12)

Consequently, the matrix Mₜ₊₁ can be calculated from the matrix Mₜ and the image motion determined between the t-th digital image and the t+1-th digital image: clearly, the camera path can be calculated iteratively. The following holds true:

Mₜ₊₁⁻¹=M_{I}Mₜ⁻¹ (13)

If the camera path is determined iteratively for all points t in accordance with equation (13), the errors made in the course of the image motion between two temporally successive images accumulate, however.

Therefore, in step 503, the matrix given in accordance with equation (14) is determined and considered as an approximation of the camera path (motion of the represented excerpt) given by the matrix Mₜ₊₁ from the instant t to the instant t+1. This approximation is designated by \tilde{M}ₜ₊₁. The following equation correspondingly holds true for \tilde{M}ₜ₊₁:

Mₜ₊₁=MₜM_{T}⁻¹ (14)

The following equation holds true analogously to equation (10):

\tilde{B}ₜ₊₁=\tilde{M}ₜ₊₁Pₜ₊₁ (16)

where \tilde{B}ₜ₊₁ is the estimation of the coordinates in the system of coordinates of the overall image of the point whose coordinates in the system of coordinates of the t+1-th digital image are given by the vector Pₜ₊₁, in accordance with the approximated camera path specified by \tilde{M}ₜ₊₁.

Step 504 involves determining the coordinates of feature points of the t+1-th digital image in the system of coordinates of the overall image in accordance with equation (16) and hence in accordance with the approximation of the camera path given by \tilde{M}ₜ₊₁.

Step 505 involves carrying out a motion estimation in the imaging plane. Parts of the overall image are already known from preceding registration steps since the situation of excerpts represented by the digital images preceding the t+1-th digital image has already been determined. Since the coordinates of feature points of the t+1-th digital image in the overall image are known from step 504, it is then possible to carry out, on the basis of said feature points, a feature-based motion estimation between the t+1-th digital image mapped onto the overall image in accordance with the estimated camera motion, specified by \tilde{M}ₜ₊₁, and the overall image.

Clearly, the excerpt of the overall image which is represented by the t+1-th digital image and whose situation in the overall image is specified by the estimated camera path is adapted to the overall image contents known from the preceding registration of digital images.

This is preferably carried out by means of a feature-based motion estimation with subpixel accuracy, as is explained below.

The estimated motion in the imaging plane between the overall image and the t+1-th digital image mapped into the imaging plane in accordance with \tilde{M}ₜ₊₁ shall be given by the matrix M_{B}. Consequently, the following relationship holds true:

B=M_{b}\tilde{B}ₜ₊₁ (17)

where B contains the coordinates in the system of coordinates of the overall image of the point whose coordinates in the system of coordinates of the t+1-th digital image are given by the vector Pₜ₊₁.

Step 506 involves improving the estimation of the camera path from the instant t to the instant t+1.

This can be done using M_{b} since the following holds true:

B=M_{b}\tilde{B}ₜ₊₁=M_{b}\tilde{M}ₜ₊₁Pₜ₊₁ (18)

from which follows

Mₜ₊₁=M_{b}\tilde{M}ₜ₊₁ (19)

Mₜ₊₁ specifies the camera path from the instant t to the instant t+1 with improved accuracy in comparison with \tilde{M}ₜ₊₁.

By means of the matrix Mₜ₊₁, it is possible to determine the coordinates in the system of coordinates of the overall image of the points of the t+1-th digital image in accordance with

Bₜ₊₁=Mₜ₊₁Pₜ₊₁ (20)

Step 507 involves determining the coordinates of the feature points of the t+1-th digital image in the system of coordinates of the overall image.

In step 508, all feature points of the t+1-th digital image which are not yet contained in the overall image are integrated into the overall image in accordance with the coordinates determined in step 507.

Clearly, only feature points are therefore used for determining the camera path and, accordingly, only feature points or the coordinates of feature points are included in the overall image and it is only after the determination of the camera path for all the recorded digital images that the overall image is constructed on the basis of the image registration determined.

It is assumed in this embodiment that the imaging plane and the image plane are identical at the beginning of the image registration, that is to say that the first digital image of the sequence of digital images represents an excerpt of the overall image identically, that is to say without distortions, rotations, scalings and displacements. Consequently,

$${M}_{0} = [ \begin{matrix}1 & 0 & 0 \\ 0 & 1 & 0 \\ 0 & 0 & 1\end{matrix} ] \qquad ( 21 )$$

and correspondingly

B=P₀ (22)

hold true for all points of the first digital image.

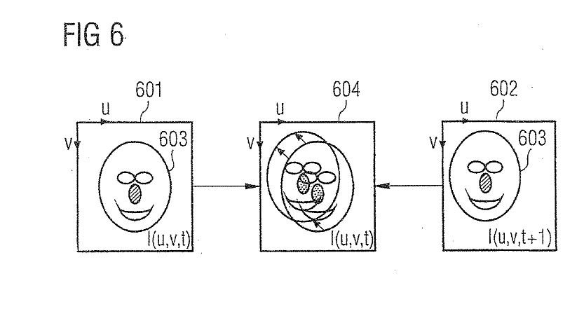

FIG. 6 illustrates the motion estimation between two temporally successive images.

A first digital image 601, which is assigned to the instant t, and a second digital image 602, which is assigned to the instant t+1, represent an object 603 in this example.

The object 603 is located at a different position in the first digital image than in the second digital image. Clearly, a motion model is then determined which maps the position of the object 603 in the first digital image 601 onto the position of the object 603 in the second digital image, as is represented in the middle imaging 604 by superposition of the object 603 at the position which it has in the first digital image and of the object 603 at the position which it has in the second digital image 602.

Methods for motion estimation between two temporally successive digital images are explained further below.

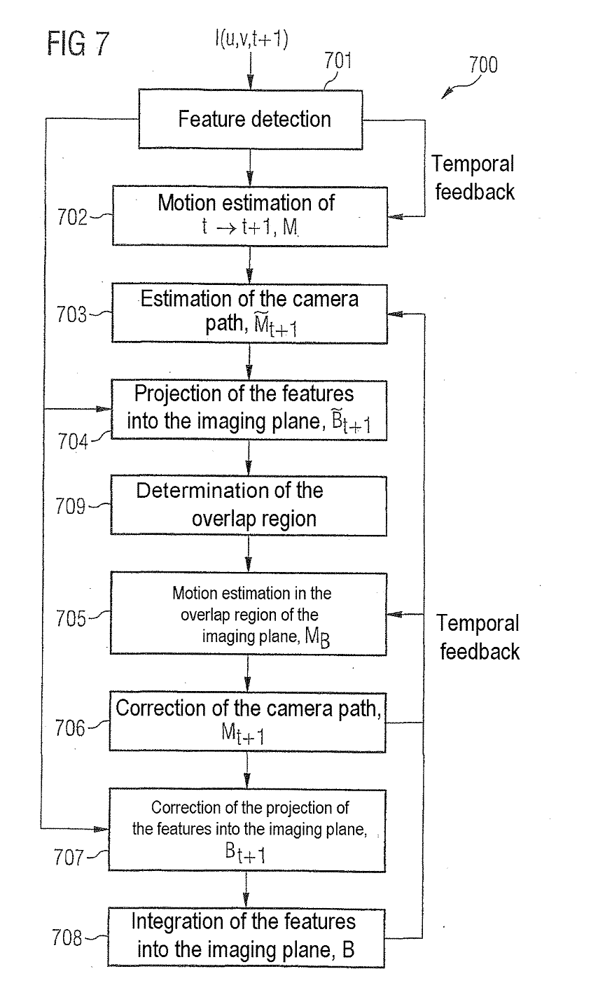

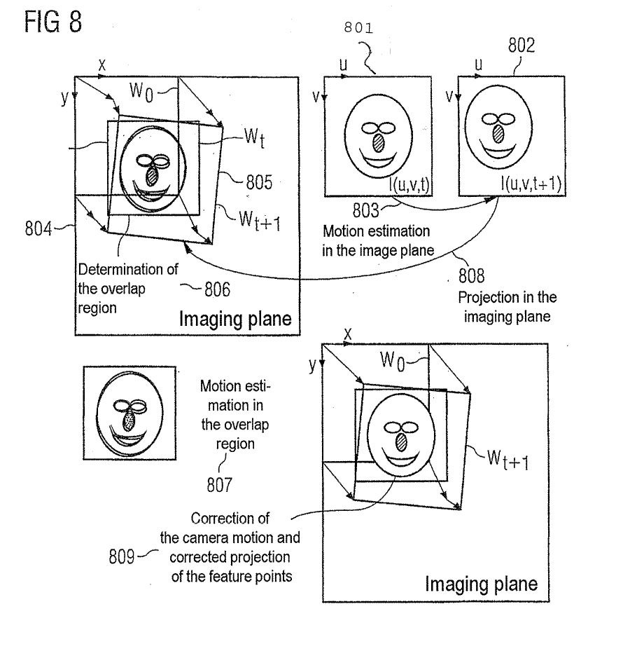

A further exemplary embodiment of the invention is explained below with reference to FIG. 7 and FIG. 8.

FIG. 7 shows a flow diagram 700 in accordance with one exemplary embodiment of the invention.

The sequence steps 701 to 704 and 706 to 708 are carried out analogously to the sequence steps 501 to 504 and 506 to 508 as explained above with reference to FIG. 5.

In this embodiment, however, two sequence steps 709 and 705 are carried out instead of the motion estimation in the imaging plane for determining the matrix M_{B} in step 505.

Step 709 involves firstly determining the overlap region between the t+1-th digital image projected into the imaging plane, that is to say onto the overall image, in accordance with \tilde{M}ₜ₊₁ and the overall image. Clearly, therefore, that excerpt of the overall image which corresponds to the t+1-th digital image projected into the imaging plane by \tilde{M}ₜ₊₁ is determined.

Step 705 involves determining the motion estimation between the overlap region and the t+1-th digital image projected by means of \tilde{M}ₜ₊₁. The result of said motion estimation shall be given by M_{B}.

Clearly, therefore, the t+1-th digital image projected into the imaging plane by \tilde{M}ₜ₊₁ is not compared with the complete overall image for correction of the camera path from t to t+1, but rather only within the relevant overlap region. Therefore, this embodiment is less computationally intensive and less memory-intensive in comparison with the embodiment explained with reference to FIG. 5.

Since the overlap region can be located at an arbitrary position in the overall image, the local system of coordinates of the overlap region does not correspond to the system of coordinates of the overall image. Clearly, therefore, a coordinate transformation is carried out when cutting out the points of the overall image of the overlap region. By way of example, if the overlap region has the form of a rectangle and the top left corner point has specific coordinates in the system of coordinates of the overall image, then the top left corner point could have the coordinates (0,0) in the local system of coordinates of the overlap region.

The coordinate transformation between the system of coordinates of the overall image and the system of coordinates of the overlap region can be modeled by a translation. The translation shall be given by a translation vector

$${\underline{T}}_{\ddot{U}} = [ \begin{matrix}{t}_{\ddot{U} , x} \\ {t}_{\ddot{U} , y} \\ 1\end{matrix} ] \qquad ( 23 )$$

In order to take account of the coordinate transformation, for the vector \tilde{B}ₜ₊₁, which, as described above, specifies an estimation of the coordinates of a point in the overall image, and the vector B, which, as described above, specifies the coordinates of a point in the system of coordinates of the overall image, substitutions are introduced in accordance with

B′=B+T_{U} (24)

and

\tilde{B}′ₜ₊₁=\tilde{B}ₜ₊₁+T_{U} (25)

The following holds true analogously to equation (17):

B′=M_{B}\tilde{B}′ₜ₊₁. (26)

The following consequently holds true:

$${\underline{B}}^{′} = {\underline{M}}_{B} {\tilde{\underline{B}}}_{t + 1} \\ ⇔ \underline{B} + {\underline{T}}_{\ddot{U}} = {\underline{M}}_{B} ( {\tilde{\underline{B}}}_{t + 1} + {\underline{T}}_{\ddot{U}} ) \\ ⇔ \underline{B} = {\underline{M}}_{B} {\tilde{\underline{B}}}_{t + 1} + {\underline{M}}_{B} {\underline{T}}_{\ddot{U}} - {\underline{T}}_{\ddot{U}} \\ ⇔ \underline{B} = [ \begin{matrix}{m}_{B , 00} & {m}_{B , 01} & {t}_{B , x} \\ {m}_{B , 10} & {m}_{B , 11} & {t}_{B , x} \\ 0 & 0 & 1\end{matrix} ] [ \begin{matrix}{\tilde{B}}_{x} \\ {\tilde{B}}_{y} \\ 1\end{matrix} ] + [ \begin{matrix}{m}_{B , 00} & {m}_{B , 01} & {t}_{B , x} \\ {m}_{B , 10} & {m}_{B , 11} & {t}_{B , x} \\ 0 & 0 & 1\end{matrix} ] [ \begin{matrix}{t}_{\ddot{U} , x} \\ {t}_{\ddot{U} , y} \\ 1\end{matrix} ] + [ \begin{matrix}{t}_{\ddot{U} , x} \\ {t}_{\ddot{U} , y} \\ 1\end{matrix} ] \qquad ( 27 )$$

where

$${\underline{M}}_{B} = [ \begin{matrix}{m}_{B , 00} & {m}_{B , 01} & {t}_{B , x} \\ {m}_{B , 10} & {m}_{B , 11} & {t}_{B , x} \\ 0 & 0 & 1\end{matrix} ] \qquad ( 28 )$$

and

$${\tilde{\underline{B}}}_{t + 1} = [ \begin{matrix}{\tilde{B}}_{x} \\ {\tilde{B}}_{y} \\ 1\end{matrix} ] . \qquad ( 29 )$$

By means of the abbreviating notation

$$[ \begin{matrix}{t}_{\ddot{U} , x}^{′} \\ {t}_{\ddot{U} , y}^{′} \\ 1\end{matrix} ] = [ \begin{matrix}{m}_{B , 00} {t}_{\ddot{U} , x} + {m}_{B , 01} {t}_{\ddot{U} , y} + {t}_{B , x} + {t}_{\ddot{U} , x} \\ {m}_{B , 10} {t}_{\ddot{U} , x} + {m}_{B , 11} {t}_{\ddot{U} , y} + {t}_{B , y} + {t}_{\ddot{U} , y} \\ 1\end{matrix} ] \qquad ( 30 )$$

the following thus results:

$$\underline{B} = [ \begin{matrix}{m}_{B , 00} & {m}_{B , 01} & {t}_{B , x} \\ {m}_{B , 10} & {m}_{B , 11} & {t}_{B , x} \\ 0 & 0 & 1\end{matrix} ] [ \begin{matrix}{\tilde{B}}_{x} \\ {\tilde{B}}_{y} \\ 1\end{matrix} ] + [ \begin{matrix}{t}_{\ddot{U} , x}^{′} \\ {t}_{\ddot{U} , y}^{′} \\ 1\end{matrix} ] \\ \begin{matrix}⇔ \underline{B} = [ \begin{matrix}{m}_{B , 00} {\tilde{B}}_{x} + {m}_{B , 01} {\tilde{B}}_{y} + {t}_{B , x} + {t}_{\ddot{U} , x}^{′} \\ {m}_{B , 10} {\tilde{B}}_{x} + {m}_{B , 11} {\tilde{B}}_{y} + {t}_{B , y} + {t}_{\ddot{U} , y}^{′} \\ 1\end{matrix} ] \\ = [ \begin{matrix}{m}_{B , 00} & {m}_{B , 01} & {t}_{B , x}^{′} \\ {m}_{B , 10} & {m}_{B , 11} & {t}_{B , x}^{′} \\ 0 & 0 & 1\end{matrix} ] [ \begin{matrix}{\tilde{B}}_{x} \\ {\tilde{B}}_{y} \\ 1\end{matrix} ] = {\underline{M}}_{B}^{′} {\underline{\tilde{B}}}_{t + 1}\end{matrix} \qquad ( 31 )$$

where

$${\underline{M}}_{B}^{′} = [ \begin{matrix}{m}_{B , 00} & {m}_{B , 01} & {t}_{B , x}^{′} \\ {m}_{B , 10} & {m}_{B , 11} & {t}_{B , x}^{′} \\ 0 & 0 & 1\end{matrix} ] \qquad ( 32 )$$

Analogously to equation (19), Mₜ₊₁ is then determined in accordance with

Mₜ₊₁=M′_{B}\tilde{M}ₜ₊₁ (33)

In order to afford a better understanding, the sequence illustrated in FIG. 7 is clearly explained below with reference to FIG. 8.

FIG. 8 illustrates the image registration in accordance with one exemplary embodiment of the invention.

The t-th digital image 801 and the t+1-th digital image 802 are illustrated in FIG. 8.

In a manner corresponding to step 702, step 803 involves carrying out a motion estimation in the image plane, that is to say determining the image motion between the t-th digital image 801 and the t+1-th digital image 802.

From this, an estimation of the camera path and hence the position of that excerpt of the overall image which is represented by the t+1-th digital image 802 in the imaging plane 804 are determined in a manner corresponding to step 703. In a manner corresponding to step 704, the feature points of the t+1-th digital image 802 are projected into the imaging plane 804 in step 808.

That excerpt of the overall image which is represented by the t+1-th digital image 802 shall have a position 805. In a manner corresponding to step 709, a determination of the overlap region is carried out in step 806.

In a manner corresponding to step 705, a motion estimation in the overlap region is carried out in step 807.

On the basis of the result of this motion estimation, in step 809, a camera motion corrected relative to the estimated camera motion is determined and, in accordance with the corrected camera motion, the feature points of the t+1-th digital image 802 are projected into the imaging plane and features that are not yet contained in the overall image generated in the course of the previous image registration are integrated into the overall image.

In the motion estimations carried out in the context of the exemplary embodiments explained above, affine motion models were used for modeling the estimated motions. Since perspective imagings of three-dimensional scenes onto a two-dimensional image plane are generated by means of a digital camera, affine models are inadequate in some cases, however, and only a low accuracy can be achieved with the use of affine models.

Therefore, a further embodiment makes use of perspective motion models, which allow the imaging properties of an ideal pinhole camera to be modeled.

The embodiment explained below differs from the embodiment formulae explained above only in that a perspective motion model is used instead of an affine motion model.

With the use of a perspective motion model instead of an affine motion model given by a matrix M of the form given in equation (4), equation (3) has the form

$$\begin{matrix}{\underline{W}}_{t + 1} = Mot ( {\underline{W}}_{t} , \underline{M} ) \\ = \frac{1}{{m}_{7} {w}_{t , x} + {m}_{8} {w}_{t , y} + {m}_{9}} [ \begin{matrix}{m}_{1} {w}_{t , x} + {m}_{2} {w}_{t , y} + {m}_{3} \\ {m}_{4} {w}_{t , x} + {m}_{5} {w}_{t , y} + {m}_{6}\end{matrix} ]\end{matrix} \qquad ( 34 )$$

where M now is not the matrix specifying an affine motion, but rather is the parameter vector of the perspective motion model and has the form

M=[m₁,m₂,m₃,m₄,m₅,m₆,m₇,m₈,m₉] (35)

Correspondingly, the following equation holds true analogously to equation (5):

$$\begin{matrix}{\underline{W}}_{t} = Mot ( {\underline{W}}_{0} , {\underline{M}}_{t} ) \\ = \frac{1}{{m}_{t , 7} {w}_{0 , x} + {m}_{t , 8} {w}_{0 , y} + {m}_{t , 9}} [ \begin{matrix}{m}_{t , 1} {w}_{0 , x} + {m}_{t , 2} {w}_{0 , y} + {m}_{t , 3} \\ {m}_{t , 4} {w}_{0 , x} + {m}_{t , 5} {w}_{0 , y} + {m}_{t , 6}\end{matrix} ]\end{matrix} \qquad ( 36 )$$

and the following equation holds true analogously to equation (7):

$$\begin{matrix}{\underline{W}}_{t} = Mot ( {\underline{W}}_{0} , {\underline{M}}_{t + 1} ) \\ = \frac{1}{{m}_{t + 1 , 7} {w}_{0 , x} + {m}_{t + 1 , 8} {w}_{0 , y} + {m}_{t + 1 , 9}} \\ [ \begin{matrix}{m}_{t + 1 , 1} {w}_{0 , x} + {m}_{t + 1 , 2} {w}_{0 , y} + {m}_{t + 1 , 3} \\ {m}_{t + 1 , 4} {w}_{0 , x} + {m}_{t + 1 , 5} {w}_{0 , y} + {m}_{t + 1 , 6}\end{matrix} ]\end{matrix} \qquad ( 37 )$$

As in the embodiments described above, a motion estimation between the t-th digital image and the t+1-th digital image is carried out, so that the following holds true analogously to equation (6):

$$\begin{matrix}{\underline{P}}_{t + 1} = Mot ( {\underline{P}}_{t} , {\underline{M}}_{I} ) \\ = \frac{1}{{m}_{I , 7} {p}_{t , x} + {m}_{I , 8} {p}_{t , y} + {m}_{I , 9}} [ \begin{matrix}{m}_{I , 1} {p}_{t , x} + {m}_{I , 2} {p}_{t , y} + {m}_{I , 3} \\ {m}_{I , 4} {p}_{t , x} + {m}_{I , 5} {p}_{t , y} + {m}_{I , 6}\end{matrix} ] .\end{matrix} \qquad ( 38 )$$

\tilde{M}ₜ₊₁ is then determined such that the following holds true analogously to equation (12):

Pₜ₊₁=Mot(Pₜ,M_{I})=Mot(Mot(B,Mₜ⁻¹),M_{I})=Mot(B,\tilde{M}ₜ₊₁⁻¹). (39)

In this case, Mₜ⁻¹ and \tilde{M}ₜ₊₁⁻¹ specify the inverse motions with respect to Mₜ and \tilde{M}ₜ₊₁, respectively. The following therefore holds true for two points P₁, P₂ and a matrix M specifying a perspective motion:

P₂=Mot(P₁,M) [symbol] P₁=Mot(P₂,M⁻¹) (40)

The vector M⁻¹ can be determined directly from M. The motion model used has eight degrees of freedom (clearly, one of the components of the vector M given by equation 35 can be nominated at 1). If four pairwise linearly independent points are inserted into the left-hand equation of (40), then four equations are obtained in accordance with

P_{2,i}=Mot(P₁,i,M) where i=1,2,3,4 (41)

where the point P_{1,i} (for i=1,2,3,4) is mapped onto the point P_{2,i} by the perspective motion given by M. This yields a system of linear equations having eight equations in accordance with

$$( {n}_{7} {p}_{2 , i , x} + {n}_{8} {p}_{2 , i , y} + 1 ) {\underline{p}}_{1 , i} = [ \begin{matrix}{n}_{1} {p}_{2 , i , x} + {n}_{2} {p}_{2 , i , y} + {n}_{3} \\ {n}_{4} {p}_{2 , i , x} + {n}_{5} {p}_{2 , y} + {n}_{6}\end{matrix} ] \\ where \\ i = 1 , 2 , 3 , 4 \qquad ( 42 )$$

By an analogous procedure it is possible to determine a matrix M₃, for which

P₃=Mot(P₂,M₂)=Mot(Mot(P₁,M₁),M₂)=Mot(P₁,M₃) (43)

holds true. In particular, the matrix \tilde{M}ₜ₊₁ can be determined in this way from equation (39), that is to say by a sufficient number of linear equations being generated by inserting a set of pairs of points in each case comprising a point of the t-th digital image and of the t+1-th digital image. Pairs of points which can be used for insertion into equation (39) are those which correspond to the same point in the overall image, and can be determined for example by means of the method for motion estimation of two temporally successive digital images that is described below.

Analogously to the embodiments described above, on the basis of the estimated camera motion given by \tilde{M}ₜ₊₁ and a motion estimation in the imaging plane, a corrected camera motion is determined which is given by Mₜ₊₁ and by means of which the following holds true analogously to equation (20):

B=Mot(\tilde{B}ₜ₊₁,M_{B})=Mot(Mot(Pₜ₊₁,\tilde{M}ₜ₊₁),M_{B})=Mot(Pₜ₊₁,Mₜ₊₁) (44)

A comparison of the embodiment described in which a perspective model is used with a corresponding method for image registration in which, however, a motion estimation in the imaging plane and a corresponding correction of the camera path are dispensed with shows that the errors made during the motion estimation of two temporally successive digital images accumulate in the conventional method, whereas that is not the case in the embodiment described above, and the overall error is therefore considerably smaller. Particularly when determining motion parameters which describe a translation component of the calculated camera motion, a very high accuracy is achieved by means of the embodiment described.

An explanation is given below of a method for motion estimation in two temporally successive images which can be used in the context of the above exemplary embodiments.

Clearly, in the method described below, the motion determination is effected by means of a comparison of feature positions.

Hereinafter, an image is always to be understood to mean a digital image.

To put it clearly, features are determined in two successive images and an assignment is determined by attempting to determine those features in the second image to which the features in the first image respectively correspond. If that feature in the second image to which a feature in the first image corresponds has been determined, then this is interpreted such that the feature in the first image has migrated to the position of the feature in the second image and this position change, which corresponds to an image motion of the feature, is calculated. Furthermore, a uniform motion model which models the position changes as well as possible is calculated on the basis of the position changes of the individual features.

Clearly, therefore, an assignment is fixedly chosen and a motion model is determined which best maps all feature points of the first image onto the feature points—respectively assigned to them—of the second image in a certain sense, for example in a least squares sense as described below.

In particular, a distance between the set of feature points of the first image that is mapped by means of the motion model and the set of the feature points of the second image is not calculated for all values of the parameters of the motion model. Consequently, a low computational complexity is achieved in the case of the method provided.

Features are points of the image which are significant in a certain predetermined sense, for example edge points.

An edge point is a point of the image at which a great local change in brightness occurs; for example, a point whose neighbor on the left is black and whose neighbor on the right is white is an edge point.

Formally, an edge point is determined as a local maximum of the image gradient in the gradient direction or is determined as a zero crossing of the second derivative of the image information.

Further image points which can be used as feature points in the method provided are e.g.:
gray-scale value corners, that is to say pixels which have a local maximum of the image gradient in the x and y direction.
corners in contour profiles, that is to say pixels at which a significant high curvature of a contour occurs.
pixels with a local maximum filter response in the case of filtering with local filter masks (e.g. sobel operator, gabor functions, etc.).
pixels which characterize the boundaries of different image regions. These image regions are generated e.g. by image-segmentations such as “region growing” or “watershed segmentation”.
pixels which describe centroids of image regions, as are generated for example by the image segmentations mentioned above.

The positions of a set of features are determined by a two-dimensional spatial feature distribution of an image.

In the determination of the motion of a first image and a second image in accordance with the method provided, clearly the spatial feature distribution of the first image is compared with the spatial feature distribution of the second image.

In contrast to a method based on the optical flow, in the case of the method provided the motion is not calculated on the basis of the brightness distribution of the images, but rather on the basis of the spatial distribution of significant points.

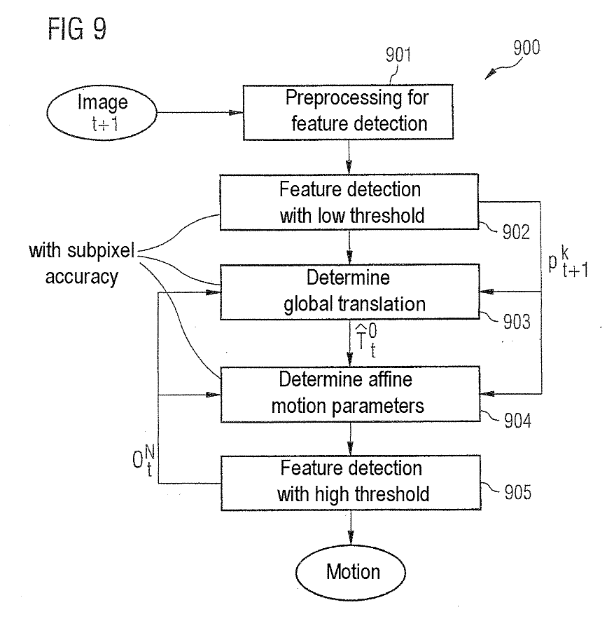

FIG. 9 shows a flow diagram 900 of a method in accordance with one exemplary embodiment of the invention.

The method explained below serves for calculating the motion in a sequence of digital images that have been recorded by means of a digital camera. Each image of the sequence of digital images is expressed by a function I(x,y,t), where t is the instant at which the image was recorded and I(x,y,t) specifies the coding information of the image at the location (x,y) which was recorded at the instant t.

It is assumed in this exemplary embodiment that no illumination fluctuations or disturbances in the processing hardware occurred during the recording of the digital images.

Under this assumption, the following equation holds true for two successive digital images in the sequence of digital images with the coding information I(x,y,t) and I(x,y,t+dt), respectively:

I(x+dx,y+dy,t+dt)=I(x,y,t) (45)

In this case, dt is the difference between the recording instants of the two successive digital images in the sequence of digital images.

Under the assumption that only one cause of motion exists, equation (45) can also be formulated by

I(x,y,t+dt)=I(Motion(x,y,t),t) (46)

where Motion(x,y,t) describes the motion of the pixels.

The image motion can be modeled for example by means of an affine transformation

$$[ \begin{matrix}x ( t + dt ) \\ y ( t + dt )\end{matrix} ] = [ \begin{matrix}{m}_{x0} & {m}_{x 1} \\ {m}_{y 0} & {m}_{y 1}\end{matrix} ] [ \begin{matrix}x ( t ) \\ y ( t )\end{matrix} ] + [ \begin{matrix}{t}_{x} \\ {t}_{y}\end{matrix} ] . \qquad ( 47 )$$

An image of the sequence of digital images is provided in step 901 of the flow diagram 900.

It is assumed that the digital image was recorded by means of the digital camera at an instant t+1.

An image that was recorded at an instant τ is designated hereinafter as image τ for short.

Consequently, by way of example, the image that was recorded by means of the digital camera at an instant t+1 is designated as image t+1.

It is furthermore assumed that a digital image that was recorded at an instant t is present, and that the image motion from the image t to the image t+1 is to be determined.

The feature detection, that is to say the determination of feature points and feature positions, is prepared in step 902.

By way of example, the digital image is preprocessed by means of a filter for this purpose.

A feature detection with a low threshold is carried out in step 902.

This means that, during the feature detection, a value is assigned to each pixel, and a pixel belongs to the set of feature points only when the value assigned to it lies above a certain threshold value.

In the case of the feature detection carried out in step 902, said threshold value is low, where “low” is to be understood to mean that the value is less than the threshold value of the feature detection carried out in step 905.

A feature detection in accordance with a preferred embodiment of the invention is described further below.

The set of feature points that is determined during the feature detection carried out in step 902 is designated by Pₜ₊₁^{K}:

Pₜ₊₁^{K}={[P_{t+1,x}(k),P_{t+1,y}(k)]^{T},0≦k≦K−1} (48)

In this case, Pₜ₊₁=[P_{t+1,x}(k), P_{t+1,y}(k)]^{T} designates a feature point with the index k from the set of feature points Pₜ₊₁^{K} in vector notation.

The image information of the image t is written as function I(x,y,t) analogously to above.

A global translation is determined in step 903.

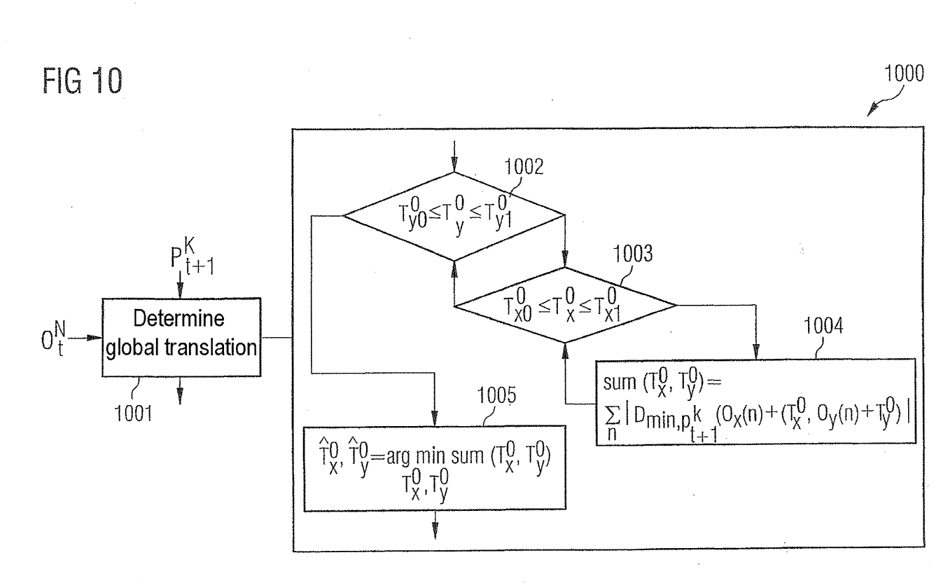

This step is described below with reference to FIG. 10.

Affine motion parameters are determined in step 904.

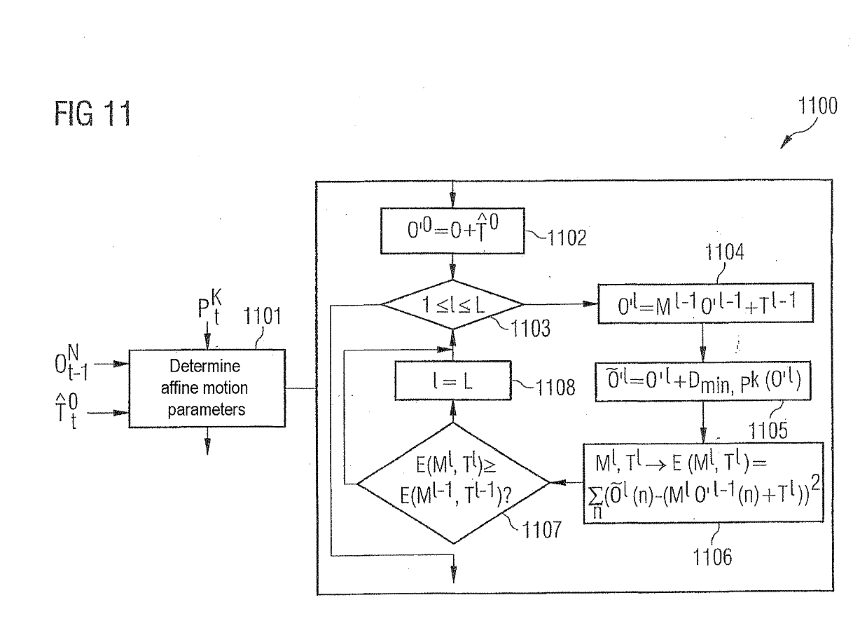

This step is described below with reference to FIG. 11.

A feature detection with a high threshold is carried out in step 905.

In other words, the threshold value is high during the feature detection carried out in step 905, where high is to be understood to mean that the value is greater than the threshold value of the feature detection with a low threshold value that is carried out in step 902.

As mentioned, a feature detection in accordance with a preferred embodiment of the invention is described further below.

The set of feature points determined during the feature detection carried out in step 905 is designated by Oₜ₊₁^{N}:

Oₜ₊₁^{N}={[O_{t+1,x}(n),O_{t+1,y}(n)]^{T},0≦n≦N−1} (49)

In this case, Oₜ₊₁(n)=[O_{t+1,x}(n), O_{t+1,y}(n)]^{T} designates the n-th feature point of N the set Oₜ₊₁^{N} in vector notation.

The feature detection with a high threshold that is carried out in step 905 does not serve for determining the motion from image t to image t+1, but rather serves for preparing for the determination of motion from image t+1 to image t+2.

Accordingly, it is assumed hereinafter that a feature detection with a high threshold for the image t analogously to step 905 was carried out in which a set of feature points

Oₜ^{N}={[O_{t,x}(n),O_{t,y}(n)]^{T},0≦n≦N−1} (50)

was determined.

Step 903 and step 904 are carried out using the set of feature points Oₜ^{N}.

In step 903 and step 904, a suitable affine motion determined by a matrix \hat{M}ₜ and a translation vector \hat{T}ₜ is calculated, so that for

Ôₜ₊₁^{N}=\hat{M}ₜOₜ^{N}+\hat{T}ₜ (51)

the relationship

Ôₜ₊₁^{N}⊂Pₜ₊₁^{N} (52)

holds true, where Ôₜ₊₁^{N} is the set of column vectors of the matrix Ôₜ₊₁^{N}.

In this case, Oₜ^{N} designates the matrix whose column vectors are the vectors of the set Oₜ^{N}.

This can be interpreted such that a motion is sought which maps the feature points of the image t onto feature points of the image t+1.

The determination of the affine motion is made possible by the fact that a higher threshold is used for the detection of the feature points from the set Oₜ^{N} than for the detection of the feature points from the set Pₜ₊₁^{K}.

If the same threshold is used for both detections, there is the possibility that some of the pixels corresponding to the feature points from Oₜ^{N} will not be detected as feature points at the instant t+1.

The pixel in image t+1 that corresponds to a feature point in image t is to be understood as the pixel at which the image content constituent represented by the feature point in image t is represented in image t+1 on account of the image motion.

In general, \hat{M}ₜ and \hat{T}ₜ cannot be determined such that (52) holds true, therefore \hat{M}ₜ and \hat{T}ₜ are determined such that Oₜ^{N} is mapped onto Pₜ₊₁^{K}, as well as possible by means of the affine motion in a certain sense, as is defined below.

In this embodiment, the minimum distances of the points from Ôₜ^{N} to the set Pₜ₊₁^{K} are used for a measure of the quality of the mapping of Oₜ^{N} onto Pₜ₊₁^{K}.

The minimum distance |D_{min,P}_{ₜ₊₁}_{^{K}}(x, y)| of a point (x,y) from the set Pₜ₊₁^{K} is defined by

$$\vert {D}_{min , {P}_{t + 1}^{K}} ( x , y ) \vert = {min}_{k} \vert {[ x , y ]}^{T} - {P}_{t + 1} ( k ) \vert \qquad ( 53 )$$

The minimum distances of the points from Oₜ^{N} from the set pₜ₊₁^{K} can be determined efficiently for example with the aid of a distance transformation, which is a morphological operation (see G. Borgefors, Distance Transformation in Digital Images, Computer Vision, Graphics and Image Processing, 34, pp. 344-371, 1986).

In the case of a distance transformation such as is described in G. Borgefors, a distance image is generated from an image in which feature points are identified, in which distance image the image value at a point specifies the minimum distance to a feature point.

Clearly, |D_{min,P}_{ₜ₊₁}_{^{K}}(x, y)| specifies for a point the distance to the point from Pₜ₊₁^{K} with respect to which the point (x,y) has the smallest distance.

The affine motion is determined in the two steps 903 and 904.

For this purpose, the affine motion formulated in (51) is decomposed into a global translation and a subsequent affine motion:

Ôₜ₊₁^{N}=\hat{M}ₜ(Oₜ^{N}+\hat{T}ₜ⁰)+\hat{T}ₜ¹ (54)

The translation vector \hat{T}ₜ⁰ determines the global translation and the matrix \hat{M}ₜ and the translation vector \hat{T}ₜ¹ determine the subsequent affine motion.

Step 903 is explained below with reference to FIG. 10.

FIG. 10 shows a flow diagram 1000 of a determination of a translation in accordance with one exemplary embodiment of the invention.

In step 903, which is represented by step 1001 of the flow diagram 1000, the translation vector is determined using Pₜ₊₁^{K} and Oₜ^{N} such that

$${\hat{T}}_{t}^{0} = {arg min}_{{T}_{t}^{0}} {\sum }_{n} \vert {D}_{min , {P}_{t + 1}^{K}} ( {O}_{tx} ( n ) + {T}_{tx}^{0} , {O}_{ty} ( n ) + {T}_{ty}^{0} ) \vert \qquad ( 55 )$$

Step 1001 has steps 1002, 1003, 1004 and 1005.

For the determination of \hat{T}ₜ⁰, such that equation (55) holds true, step 1002 involves choosing a value T_{y}⁰ in an interval [\hat{T}_{y0}⁰, \hat{T}_{y1}⁰].

Step 1003 involves choosing a value Tₓ⁰ in an interval [\hat{T}ₓ₀⁰, \hat{T}ₓ₁⁰].

Step 1004 involves determining the value sum (Tₓ⁰, T_{y}⁰) in accordance with the formula

$$sum ( {\underline{T}}_{x}^{0} , {\underline{T}}_{y}^{0} ) = {\sum }_{n} \vert {\underline{D}}_{min , {P}_{t + 1}^{K}} ( {\underline{O}}_{tx} ( n ) + {\underline{T}}_{tx}^{0} , {\underline{O}}_{ty} ( n ) + {\underline{T}}_{ty}^{0} ) \vert \qquad ( 56 )$$

for the chosen values Tₓ⁰ and T_{y}⁰.

Steps 1002 to 1004 are carried out for all chosen pairs of values T_{y}⁰ε[\hat{T}_{y0}⁰, \hat{T}_{y1}⁰] and Tₓ⁰ε[\hat{T}ₓ₀⁰, \hat{T}ₓ₁⁰].

In step 1005, and \hat{T}_{y}⁰ and \hat{T}ₓ⁰ are determined such that sum (\hat{T}ₓ⁰, \hat{T}_{y}⁰) is equal to the minimum of all sums calculated in step 1004.

The translation vector \hat{T}ₜ⁰ is given by

\hat{T}ₜ⁰=[\hat{T}ₓ⁰,\hat{T}_{y}⁰] (57)

Step 904 is explained below with reference to FIG. 11.

FIG. 11 shows a flow diagram 1100 of a determination of an affine motion in accordance with one exemplary embodiment of the invention.

Step 904, which is represented by step 1101 of the flow diagram 1100, has steps 1102 to 1108.

Step 1102 involves calculating the matrix

O′ₜ^{N}=Oₜ^{N}+\hat{T}ₜ⁰ (58)

whose column vectors form a set of points O′ₜ^{N}.

A distance vector D_{min,P}_{ₜ₊₁}_{^{K}}(x, y) is determined for each point (x,y) from the set O′ₜ^{N}.

The distance vector is determined such that it points from the point (x,y) to the point from Pₜ₊₁^{K} with respect to which the distance of the point (x,y) is minimal.

The determination is thus effected in accordance with the equations

$$\begin{matrix}{k}_{min} = {argmin}_{k} \vert {[ x , y ]}^{T} - {P}_{t + 1} ( k ) \vert & ( 59 ) \\ {\underline{D}}_{min , {P}_{t + 1}^{K}} ( x , y ) = {[ x , y ]}^{T} - {P}_{t + 1} ( {k}_{min} ) & ( 60 )\end{matrix}$$

The distance vectors can also be calculated from the minimum distances which are present in the form of a distance image, for example, in accordance with the following formula:

$${\underline{D}}_{min , {P}_{t + 1}^{K}} ( x , y ) = \vert {\underline{D}}_{min , {P}_{t + 1}^{K}} ( x , y ) \vert [ \begin{matrix}\frac{\partial \vert {\underline{D}}_{min , {P}_{t + 1}^{K}} ( x , y ) \vert}{\partial x} \\ \frac{\partial \vert {\underline{D}}_{min , {P}_{t + 1}^{K}} ( x , y ) \vert}{\partial y}\end{matrix} ] \qquad ( 61 )$$

In steps 1103 to 1108, assuming that the approximation

Oₜ₊₁^{N}≈Õₜ₊₁^{N}=O′ₜ^{N}+D_{min,P}_{ₜ₊₁}_{^{K}}(O′ₜ^{N}) (62)

holds true for the feature point set Oₜ₊₁^{N} the affine motion is determined by means of a least squares estimation, that is to say that the matrix \hat{M}ₜ and the translation vector \hat{T}ₜ¹ are determined such that the term

$${\sum }_{n} {( {\tilde{\underline{O}}}_{t + 1} ( n ) - ( {\underline{\hat{M}}}_{t}^{1} {\underline{O}}_{t}^{′} ( n ) + {\underline{\hat{T}}}_{t}^{1} ) )}^{2} \qquad ( 63 )$$

is minimal, which is the case precisely when the term

$${\sum }_{n} {( ( {\underline{O}}_{t}^{′} ( n ) + {\underline{D}}_{min , {P}_{t + 1}^{K}} ( {\underline{O}}_{t}^{′} ( n ) ) ) - ( {\underline{\hat{M}}}_{t}^{1} {\underline{O}}_{t}^{′} ( n ) + {\underline{\hat{T}}}_{t}^{1} ) )}^{2} \qquad ( 64 )$$

is minimal.

In this case, the n-th column of the respective matrix is designated by O′ₜ(n) and Õₜ₊₁(n).

The use of the minimum distances in equation (64) can clearly be interpreted such that it is assumed that a feature point in image t corresponds to the feature point in image t+1 which lies nearest to it, that is to say that the feature point in image t has moved to the nearest feature point in image t+1.

The least squares estimation is iterated in this embodiment.

This is effected in accordance with the following decomposition of the affine motion:

\hat{M}O+\hat{T}=\hat{M}^{L}(\hat{M}^{L-1}( . . . (\hat{M}¹(O+\hat{T}⁰)+\hat{T}¹) . . . )+\hat{T}^{L-1})+\hat{T}^{L}. (65)

The temporal dependence has been omitted in equation (65) for the sake of simplified notation.

That is to say that L affine motions are determined, the L-th affine motion being determined in such a way that it maps the feature point set which arises as a result of progressive application of the 1^{st}, 2^{nd}, . . . and the (1-2)-th affine motion to the feature point set O′ₜ^{N} onto the set Pₜ₊₁^{K} as well as possible, in the above-described sense of the least squares estimation.

The 1-th affine motion is determined by the matrix \hat{M}ₜ^{l} and the translation vector \hat{T}ₜ^{l}.

At the end of step 1102, the iteration index 1 is set to zero and the procedure continues with step 1103.

In step 1103, the value of 1 is increased by one and a check is made to ascertain whether the iteration index 1 lies between 1 and L.

If this is the case, the procedure continues with step 1104.

Step 1104 involves determining the feature point set O′¹ that arises as a result of the progressive application of the 1^{st}, 2^{nd}, . . . and the (1-2)-th affine motion to the feature point set O′ₜ^{N}.

Step 1105 involves determining distance vectors analogously to equations (59) and (60) and a feature point set analogously to (62).

Step 1106 involves calculating a matrix \hat{M}ₜ^{l} and a translation vector \hat{T}ₜ^{l}, which determine the 1-th affine motion.

Moreover, a square error is calculated analogously to (63).

Step 1107 involves checking whether the square error calculated is greater than the square error calculated in the last iteration.

If this is the case, in step 1108 the iteration index 1 is set to the value L and the procedure subsequently continues with step 1103.

If this is not the case, the procedure continues with step 1103.

If the iteration index is set to the value L in step 1108, then in step 1103 the value of 1 is increased to the value L+1 and the iteration is ended.

In one preferred embodiment, steps 902 to 905 of the flow diagram 900 illustrated in FIG. 9 are carried out with subpixel accuracy.

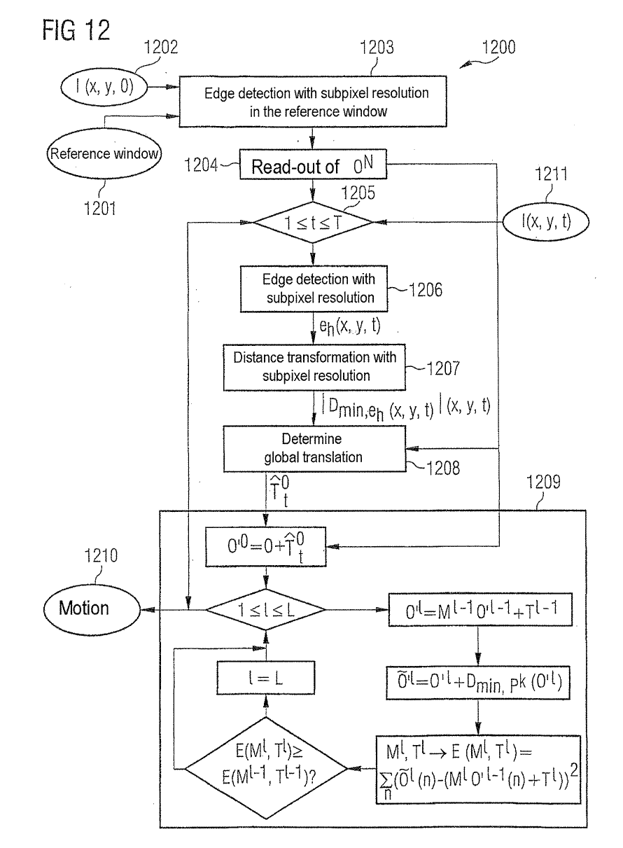

FIG. 12 shows a flow diagram 1200 of a method in accordance with a further exemplary embodiment of the invention.

In this embodiment, a digital image that was recorded at the instant 0 is used as a reference image, which is designated hereinafter as reference window.

The coding information 1202 of the reference window 1201 is written hereinafter as function I(x,y,1) analogously to the above.

Step 1203 involves carrying out an edge detection with subpixel resolution in the reference window 1201.

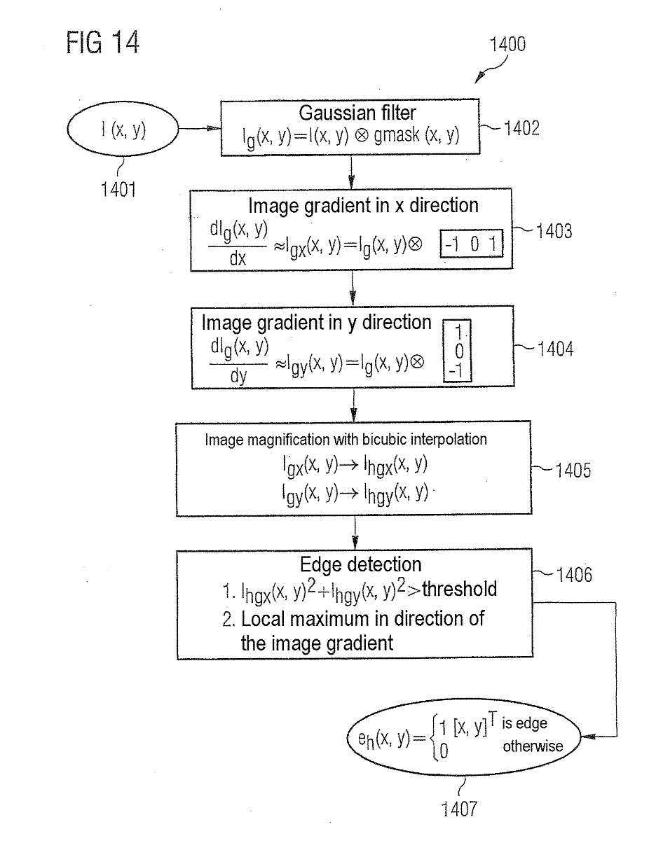

A method for edge detection with subpixel resolution in accordance with one embodiment is described below with reference to FIG. 14.

In step 1204, a set of feature points O^{N} of the reference window is determined from the result of the edge detection.

For example, the particularly significant edge points are determined as feature points.

The time index t is subsequently set to the value zero.

In step 1205, the time index t is increased by one and a check is subsequently made to ascertain whether the value of t lies between one and T.

If this is the case, the procedure continues with step 1206.

If this is not the case, the method is ended with step 1210.

In step 1206, an edge detection with subpixel resolution is carried out using the coding information 1211 of the t-th image, which is designated as image t analogously to above.

This yields, as is described in greater detail below, a t-th edge image, which is designated hereinafter as edge image t, with the coding information eₕ(x,y,t) with respect to the image t.

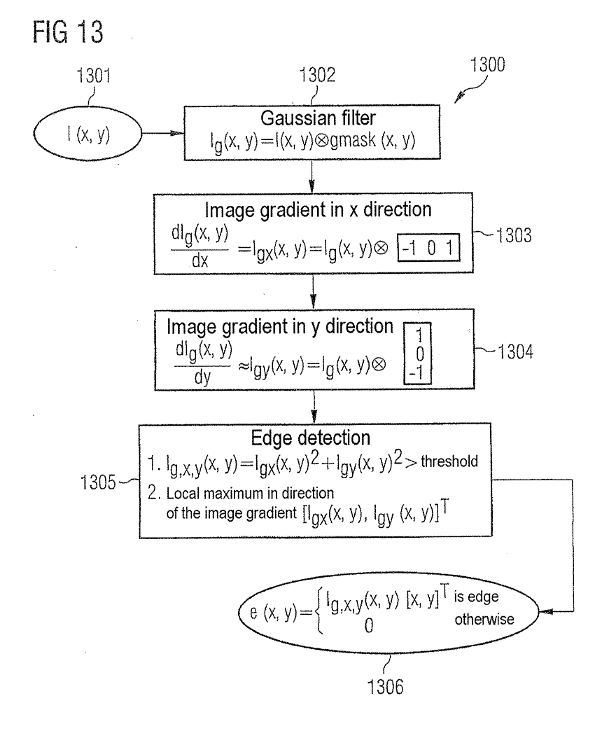

The coding information eₕ(x,y,t) of the edge image t is explained in more detail below with reference to FIG. 13 and FIG. 14.

Step 1207 involves carrying out a distance transformation with subpixel resolution of the edge image t.

That is to say that a distance image is generated from the edge image t, in the case of which distance image the image value at a point specifies the minimum distance to an edge point.

The edge points of the image t are the points of the edge image t in the case of which the coding information eₕ(x, y, t) has a specific value.

This is explained in more detail below.

The distance transformation is effected analogously to the embodiment described with reference to FIG. 9, FIG. 10 and FIG. 11.

In this case, use is made of the fact that the positions of the edge points of the image t were determined with subpixel accuracy in step 1206.

The distance vectors are calculated with subpixel accuracy.

In step 1208, a global translation is determined analogously to step 903 of the exemplary embodiment described with reference to FIG. 9, FIG. 10 and FIG. 11.

The global translation is determined with subpixel accuracy.

Parameters of an affine motion model are calculated in the processing block 1209.

The calculation is effected analogously to the flow diagram illustrated in FIG. 11 that was explained above.

The parameters of an affine motion model are calculated with subpixel accuracy.

After the end of the processing block 1209, the procedure continues with step 1205.

In particular, the method is ended if t=T, that is to say if the motion of the image content between the reference window and the T-th image has been determined.

FIG. 13 shows a flow diagram 1300 of an edge detection in accordance with one exemplary embodiment of the invention.

The determination of edges represents an expedient compromise for the motion estimation with regard to concentration on significant pixels during the motion determination and obtaining as many items of information as possible.

Edges are usually determined as local maxima in the local derivative of the image intensity. The method used here is based on the papers by J. Canny, A Computational Approach to Edge Detection, IEEE Transactions on Pattern Analysis and Machine Intelligence, 6, 1986.

In step 1302, a digital image in the case of which edges are intended to be detected is filtered by means of a Gaussian filter.

This is effected by convolution of the coding information 1301 of the image, which is given by the function I(x,y), using a Gaussian mask designated by gmask.

Step 1303 involves determining the partial derivative with respect to the variable x of the function I_{g}(x,y).

Step 1304 involves determining the partial derivative with respect to the variable x of the function I_{g}(x,y).

In step 1305, a decision is made as to whether an edge point is present at a point (x,y).

For this purpose, two conditions have to be met at the point (x,y).

The first condition is that the sum of the squares of the two partial derivatives determined in step 1303 and step 1304 at the point (x,y), designated by I_{g,x,y}(x,y) lies above a threshold value.

The second condition is that I_{g,x,y}(x,y) has a local maximum at the point (x,y).

The result of the edge detection is combined in an edge image whose coding information 1306 is written as a function and designated by e(x,y).

The function e(x,y) has the value I_{g,x,y}(x,y) at a location (x,y) if it was decided with regard to (x,y) in step 1305 that (x,y) is an edge point, and has the value zero at all other locations.

The approach for detecting gray-scale value corners as illustrated in FIG. 13 affords the possibility of controlling the number and the significance of the edges by means of a threshold.

It can thus be ensured that Oₜ₊₁^{N} is contained in Pₜ₊₁^{K}.

The point sets Oₜ₊₁^{N} and Pₜ₊₁^{K} can be read from the edge image having the coding information e(x,y).

If the method illustrated in FIG. 13 is used in the exemplary embodiment illustrated in FIG. 9, then for generating Pₜ₊₁^{K} from e(x,y) the threshold used in step 1305 corresponds to the “low threshold” used in step 905.

For determining Oₜ₊₁^{N} using the “high threshold” used in step 905, a selection is made from the edge points given by e(x,y).

This is effected for example analogously to the checking of the first condition from step 1305 as explained above.

FIG. 14 shows a flow diagram 1400 of an edge detection with subpixel accuracy in accordance with one exemplary embodiment of the invention.

Steps 1402, 1403 and 1404 do not differ from steps 1302, 1303 and 1304 of the edge detection method illustrated in FIG. 13.

In order to achieve a detection with subpixel accuracy, the flow diagram 1400 has a step 1405.

Step 1405 involves extrapolating the partial derivatives in the x direction and y direction determined in step 1403 and step 1404, which are designated as local gradient images with coding information I_{gx}(x,y) and I_{gy}(x,y), to a higher image resolution.

The missing image values are determined by means of a bicubic interpolation. The method of bicubic interpolation is explained e.g. in William H. Press, et al., Numerical Recipies in C, ISBN: 0-521-41508-5, Cambridge University Press.

The coding information of the resulting high resolution gradient images is designated by I_{hgx}(x,y) and I_{hgy}(x,y).

Step 1406 is effected analogously to step 1305 using the high resolution edge images.

The coding information 1407 of the edge image generated in step 1406 is designated by eₕ(x,y), where the index h is intended to indicate that the edge image likewise has a high resolution.

The function eₕ(x,y) generated in step 1407, in contrast to that in step 1406, in this exemplary embodiment does not have the value I_{g,x,y}(x,y) if it was decided that an edge point is present at the location (x,y), but rather the value 1.

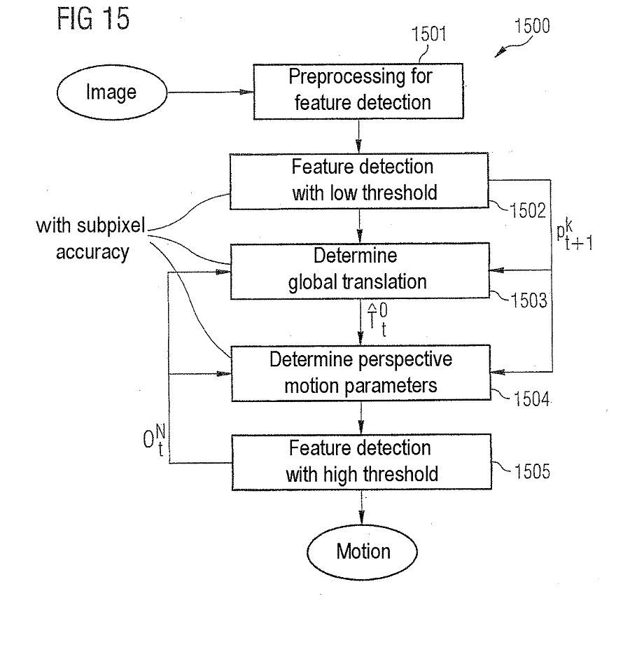

FIG. 15 shows a flow diagram 1500 of a method in accordance with a further exemplary embodiment of the invention.

This exemplary embodiment differs from that explained with reference to FIG. 9 in that a perspective motion model is used instead of an affine motion model such as is given by equation (47), for example.

Since a camera generates a perspective mapping of the three-dimensional environment onto a two-dimensional image plane, an affine model yields only an approximation of the actual image motion which is generated by a moving camera.

If an ideal camera, i.e. without lens distortions, is assumed, the motion can be described by a perspective motion model such as is given by the equation below, for example.

$$\begin{matrix}[ \begin{matrix}x ( t + dt ) \\ y ( t + dt )\end{matrix} ] = {Motion}_{pers} ( \underline{M} , x ( t ) , y ( t ) ) \\ = [ \begin{matrix}\frac{{a}_{1} x ( t ) + {a}_{2} y ( t ) + {a}_{3}}{{n}_{1} x ( t ) + {n}_{2} y ( t ) + {n}_{3}} \\ \frac{{b}_{1} x ( t ) + {b}_{2} y ( t ) + {b}_{3}}{{n}_{1} x ( t ) + {n}_{2} y ( t ) + {n}_{3}}\end{matrix} ]\end{matrix} \qquad ( 66 )$$

M designates the parameter vector for the perspective motion model.

M=[a₁,a₂,a₃,b₁,b₂,b₃,n₁,n₂,n₃] (67)

The method steps of the flow diagram 1500 are analogous to those of the flow diagram 900; therefore, only the differences are discussed below.

In particular, as in the case of the method described with reference to FIG. 9, a feature point set

Oₜ^{N}={[Oₜₓ(n),O_{ty}(n)]^{T},0≦n≦N−1} (68)

is present.

This feature point set represents an image excerpt or an object of the image which was recorded at the instant t.

The motion that maps Oₜ^{N} onto the corresponding points of the image that was recorded at the instant t+1 is now sought.

In contrast to the method described with reference to FIG. 9, the parameters of a perspective motion model are determined in step 1504.

The motion model according to equation (67) has nine parameters but only eight degrees of freedom, as can be seen from the equation below.

$$\begin{matrix}[ \begin{matrix}x ( t + dt ) \\ y ( t + dt )\end{matrix} ] = [ \begin{matrix}\frac{{a}_{1} x ( t ) + {a}_{2} y ( t ) + {a}_{3}}{{n}_{1} x ( t ) + {n}_{2} y ( t ) + {n}_{3}} \\ \frac{{b}_{1} x ( t ) + {b}_{2} y ( t ) + {b}_{3}}{{n}_{1} x ( t ) + {n}_{2} y ( t ) + {n}_{3}}\end{matrix} ] \\ = [ \begin{matrix}\frac{{n}_{3}}{{n}_{3}} \frac{\frac{{a}_{1}}{{n}_{3}} x ( t ) + \frac{{a}_{2}}{{n}_{3}} y ( t ) + \frac{{a}_{3}}{{n}_{3}}}{\frac{{n}_{1}}{{n}_{3}} x ( t ) + \frac{{n}_{2}}{{n}_{3}} y ( t ) + 1} \\ \frac{{n}_{3}}{{n}_{3}} \frac{\frac{{b}_{1}}{{n}_{3}} x ( t ) + \frac{{b}_{2}}{{n}_{3}} y ( t ) + \frac{{b}_{3}}{{n}_{3}}}{\frac{{n}_{1}}{{n}_{3}} x ( t ) + \frac{{n}_{2}}{{n}_{3}} y ( t ) + 1}\end{matrix} ] \\ = [ \begin{matrix}\frac{{a}_{1}^{′} x ( t ) + {a}_{2}^{′} y ( t ) + {a}_{3}^{′}}{{n}_{1}^{′} x ( t ) + {n}_{2}^{′} y ( t ) + {n}_{3}^{′}} \\ \frac{{b}_{1}^{′} x ( t ) + {b}_{2}^{′} y ( t ) + {b}_{3}^{′}}{{n}_{1}^{′} x ( t ) + {n}_{2}^{′} y ( t ) + {n}_{3}^{′}}\end{matrix} ]\end{matrix} \qquad ( 69 )$$

The parameters of the perspective model can be determined like the parameters of the affine model by means of a least squares estimation by minimizing the term

Eₚₑᵣₛ(a′₁,a′₂,a′₃,b′₁,b′₂,b′₃,n′₁,n′₂)=Σ((n′₁O′ₓ(n)+n′₂O′_{y}(n)+1)(O′ₓ(n)+d_{n,x})−(a′₁O′ₓ(n)+a′₂O′_{y}(n)+a′₃))²+((n′₁O′ₓ(n)+n′₂O′_{y}(n)+1)(O′_{y}(n)+d_{n,y})−(b′₁O′ₓ(n)+b′₂O′_{y}(n)+b′₃))² (70)

In this case, O′ is defined in accordance with equation (58) analogously to the embodiment described with reference to FIG. 9.

O′ₓ(n) designates the first component of the n-th column of the matrix O′ and O′_{y}(n) designates the second component of the n-th column of the matrix O′.

The minimum distance vector D_{min,P}_{ₜ₊₁}_{^{K}}(x, y) calculated in accordance with equation (60) is designated in abbreviated fashion as [d_{n,x}d_{n,y}]^{T}.

The time index t has been omitted in formula (70) for the sake of simpler representation.

Analogously to the method described with reference to FIG. 9, in which an affine motion model is used, the accuracy can be improved for the perspective model, too, by means of an iterative procedure.

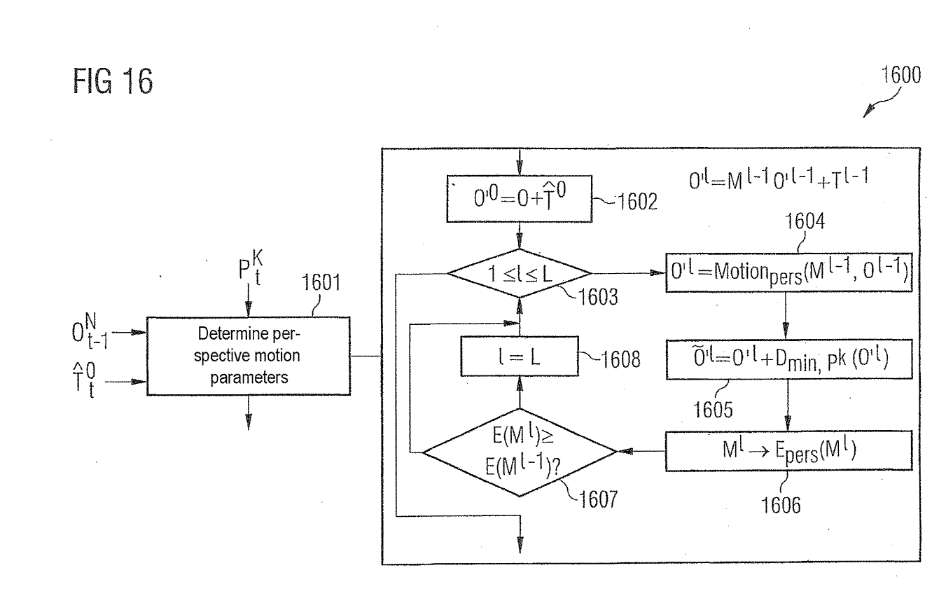

FIG. 16 shows a flow diagram 1600 of a determination of a perspective motion in accordance with an exemplary embodiment of the invention.

Step 1601 corresponds to step 1504 of the flow diagram 1500 illustrated in FIG. 15.

Steps 1602 to 1608 are analogous to steps 1102 to 1108 of the flow diagram 1100 illustrated in FIG. 11.

The difference lies in the calculation of the error Eₚₑᵣₛ, which is calculated in accordance with equation (70) in step 1606.

1-13. (canceled)

14. A method for computer-aided motion estimation in a plurality of temporally successive digital images, comprising:
first partial motion estimating in a second digital image relative to a first digital image temporally preceding the second digital image;
constructing a reference image structure from the first digital image and the second digital image based on the first partial motion estimation, the reference image structure containing at least features from the first digital image and/or the second digital image;
second partial motion estimating in a third digital image, which temporally succeeds the second digital image, relative to the second digital image;
third partial motion estimating with a comparison of features of the third digital image and of the features contained in the reference image structure; and
determining motion in the third digital image relative to the first digital image based on the third partial motion estimation, the second partial motion estimation and the first partial motion estimation.

15. The method as claimed in claim 14, further comprising, after determining the motion in the third digital image relative to the first digital image, supplementing the reference image structure by at least one feature from the third image.

16. The method as claimed in claim 14, further comprising determining motion in a fourth image, which temporally succeeds the first digital image, the second digital image and the third digital image, relative to the first digital image, the step of determining the motion in the fourth image comprising:
determining a fourth partial motion estimation in the fourth digital image relative to a further digital image which temporally precedes the fourth digital image and in which the motion relative to the first digital image has already been determined;
fifth partial motion estimating with a comparison of features of the fourth digital image and of the features contained in a reference image structure containing at least features of at least one image temporally preceding the fourth image; and
determining the motion based on the fifth partial motion estimation, the fourth partial motion estimation and the motion of the further digital image.

17. The method as claimed in claim 16, wherein the further reference image structure is a reference image structure extended by features from at least one digital image which temporally succeeds the second digital image and temporally precedes the fourth digital image.

18. The method as claimed in claim 14, wherein the partial motion estimations are carried out in a feature-based manner.

19. The method as claimed in claim 14, wherein the partial motion estimations are carried out with subpixel accuracy.

20. The method as claimed in claim 14, further comprising determining an affine motion model or a perspective motion model in each of the partial motion estimations.

21. The method as claimed in claim 14, wherein the first partial motion estimation, the second partial motion estimation and the third partial motion estimation are carried out by means of the same method for motion estimation in temporally successive images.

22. The method as claimed in claim 14, wherein, in order to carry out the third partial motion estimation, features are mapped onto the reference image structure based on the first partial motion estimation and the second partial motion estimation, and the third partial motion estimation is carried out by estimating the motion of the mapped features relative to the features contained in the reference image structure.

23. The method as claimed in claim 14, wherein each of the motion estimations is carried out in the context of generating a mosaic image, calibrating a camera, a super-resolution method, video compression or a three-dimensional estimation.

24. An arrangement for computer-aided motion estimation in a plurality of temporally successive digital images, comprising:
a first processing unit configured to carry out a first partial motion estimation in a second digital image relative to a first digital image temporally preceding the second digital image;
a second processing unit configured to construct a reference image structure from the first digital image and the second digital image based on the first partial motion estimation, the reference image structure containing at least features from the first digital image and/or the second digital image;
a third processing unit configured to carry out a second partial motion estimation in a third digital image, which temporally succeeds the second digital image, relative to the second digital image;
a fourth processing unit configured to carry out a third partial motion estimation with a comparison of features of the third digital image and of the features contained in the reference image structure; and
a fifth processing unit configured to determine motion in the third digital image relative to the first digital image based on the third partial motion estimation, the second partial motion estimation and the first partial motion estimation.

25. A computer program element which, after it has been loaded into a memory of a computer, causes the computer to conduct a method for computer-aided motion estimation in a plurality of temporally successive digital images, the method comprising:
first partial motion estimating in a second digital image relative to a first digital image temporally preceding the second digital image;
constructing a reference image structure from the first digital image and the second digital image based on the first partial motion estimation, the reference image structure containing at least features from the first digital image and/or the second digital image;
second partial motion estimating in a third digital image, which temporally succeeds the second digital image, relative to the second digital image;
third partial motion estimating with a comparison of features of the third digital image and of the features in the reference image structure; and
determining motion in the third digital image relative to the first digital image based on the third partial motion estimation, the second partial motion estimation and the first partial motion estimation.

26. A computer-readable storage medium, on which a program is stored which, after it has been loaded into a memory of a computer, causes the computer to conduct a method for computer-aided motion estimation in a plurality of temporally successive digital images, the method comprising:
first partial motion estimating in a second digital image relative to a first digital image temporally preceding the second digital image;
constructing a reference image structure from the first digital image and the second digital image based on the first partial motion estimation, the reference image structure containing at least features from the first digital image and/or the second digital image;
second partial motion estimating in a third digital image, which temporally succeeds the second digital image, relative to the second digital image;
third partial motion estimating with a comparison of features of the third digital image and of the features in the reference image structure; and
determining motion in the third digital image relative to the first digital image based on the third partial motion estimation, the second partial motion estimation and the first partial motion estimation.
